(19) United States
(12) Patent Application Publication
(10) Pub. No.: US 2025/0126646 A1
(43) Pub. Date: Apr. 17, 2025

(54) SL UNLICENSED FRAME STRUCTURE

(71) Applicant: FRAUNHOFER-GESELLSCHAFT ZUR FOERDERUNG DER ANGEWANDTEN FORSCHUNG E.V., Muenchen (DE)

(72) Inventors: Sarun SELVANESAN, Berlin (DE); Thomas WIRTH, Berlin (DE)

(21) Appl. No.: 18/927,029

(22) Filed: Oct. 25, 2024

Related U.S. Application Data
(63) Continuation of application No. PCT/EP2023/060776, filed on Apr. 25, 2023.

(30) Foreign Application Priority Data
Apr. 28, 2022 (EP) 22170639.3

(51) Int. Cl. H04W 74/0816; H04W 74/00; H04W 74/08; H04W 92/18

(52) U.S. Cl. CPC H04W 74/0816; H04W 74/002; H04W 74/0866; H04W 92/18

(57) ABSTRACT

An apparatus configured for communicating in a mobile wireless communication network, the apparatus having a wireless interface for transceiving wireless signals in the mobile wireless communication network is configured for communicating over a sidelink, SL, in the mobile wireless communication system, the sidelink providing for a plurality of time slots, each time slot having a slot duration. The apparatus is configured for using at least a first time interval of the slot duration, to perform a listen-before-talk, LBT, procedure to determine an availability of the time slot; and to use a second time interval of the slot duration for a wireless transmission based on the determined availability; and/or for using at least a first slot duration, to perform a listen-before-talk, LBT, procedure to determine an availability of a later second time slot and to use the second time slot for a wireless transmission based on the determined availability.

### CROSS-REFERENCE TO RELATED APPLICATIONS

This application is a continuation of copending International Application No. PCT/EP2023/060776, filed Apr. 25, 2023, which is incorporated herein by reference in its entirety, and additionally claims priority from European Application No. 22170639.3, filed Apr. 28, 2022, which is also incorporated herein by reference in its entirety.

### TECHNICAL FIELD

The present application relates to the field of wireless communication systems or networks, more specifically to enhancements in the communication among network entities of the communication network when performing a communication using a plurality of frequency bands, some or all of which may include frequency bands in the unlicensed spectrum.

Embodiments of the present invention concern enhancements in the feedback mechanism for reporting successful/non-successful transmissions of data or no need for redundancy for the data or a need for some redundancy for the data or an amount of additional redundancy needed for the data in a multi-band operation, for example, improvements for the hybrid automatic repeat request, HARQ, feedback.

### BACKGROUND OF THE INVENTION

FIG. 1 is a schematic representation of an example of a terrestrial wireless network 100 including, as is shown in FIG. 1A, a core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell.

The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with LTE-Advanced Pro, or the 5G or NR, New Radio, or the NR-U, New Radio Unlicensed, principle.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks, also denoted as NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with LTE-Advanced Pro or the 5G or NR, new radio, principles.

It is noted that the information in the above section is only for enhancing the understanding of the background of the invention and therefore it may contain information that does not form conventional technology that is already known to a person of ordinary skill in the art. Starting from a conventional technology as described above, there may be a need for improvements of the feedback mechanism used in a wireless communication among entities of wireless communication networks using multiple frequency bands.

### SUMMARY

An embodiment may have an apparatus configured for communicating in a mobile wireless communication network, the apparatus having a wireless interface for transceiving wireless signals in the mobile wireless communication network; wherein the apparatus is configured for communicating over a sidelink, SL, in the mobile wireless communication system, the sidelink providing for a plurality of time slots, each time slot having a slot duration, wherein the apparatus is configured for using at least a first time interval of the slot duration, to perform a listen-before-talk, LBT, procedure to determine an availability of the time slot; and/or to use a second time interval of the slot duration for a wireless transmission based on the determined availability; and/or wherein the apparatus is configured for using at least a first slot duration, to perform a listen-before-talk, LBT, procedure to determine an availability of at least a part of a later second time slot, e.g., a full slot, a mini-slot or a mini-frame, and/or to use the at least part of the later second time slot for a wireless transmission based on the determined availability.

Another embodiment may have an apparatus configured for communicating in a mobile wireless communication network, the apparatus having a wireless interface for transceiving wireless signals in the mobile wireless communication network; wherein the apparatus is configured for communicating over a sidelink, SL, in the mobile wireless communication network, with an inventive device as mentioned above.

According to another embodiment, a mobile wireless communication system may have: at least one inventive apparatus as mentioned above; and an apparatus configured for communicating in a mobile wireless communication network, the apparatus having a wireless interface for transceiving wireless signals in the mobile wireless communication network; wherein the apparatus is configured for communicating over a sidelink, SL, in the mobile wireless communication network, with an inventive device as mentioned above.

According to another embodiment, a method for operating an apparatus to communicate in a mobile wireless communication network, the apparatus having a wireless interface for transceiving wireless signals in the mobile wireless communication network, may have the steps of: communicating over a sidelink, SL, in the mobile wireless communication system, the sidelink providing for a plurality of time slots, each time slot having a slot duration, using at least a first time interval of the slot duration, to perform a listen-before-talk, LBT, procedure to determine an availability of the time slot; and to use a second time interval of the slot duration for a wireless transmission based on the determined availability; and/or using at least a first slot duration, to perform a listen-before-talk, LBT, procedure to determine an availability of at least a part of a later second time slot, e.g., a full slot, a mini-slot or a mini-frame, and/or to use the at least part of the later second time slot for a wireless transmission based on the determined availability.

According to another embodiment, a method for operating an apparatus to communicate in a mobile wireless communication network, the apparatus having a wireless interface for transceiving wireless signals in the mobile wireless communication network, may have the steps of: receiving the wireless transmission of the inventive method mentioned above; and operating accordingly.

Another embodiment may have a non-transitory digital storage medium having a computer program stored thereon to perform any of the above inventive methods when said computer program is run by a computer.

### BRIEF DESCRIPTION OF THE DRAWINGS

Embodiments of the present invention are now described in further detail with reference to the accompanying drawings:

FIGS. 1A-1B show a schematic representation of an example of a wireless communication system;

FIG. 2A shows a schematic depiction of interlaces in NR-U;

FIGS. 2B-C show schematic diagrams of example slot configurations taken from TR 37.985;

FIGS. 3A-3B show schematic diagrams of examples of LBT-based transmission in unlicensed spectrum via mini-slots;

FIG. 4 shows a schematic time timeline of a Channel Access Timeline Depiction per 3GPP time slots definition;

FIG. 5 shows an example table of slot formats for normal cyclic prefix as defined in Table 11.1.1-1 of TS38.213, Section 11.1.1;

FIG. 6 shows a schematic diagram illustrating an procedure of combining LBT with transmitting symbols according to an embodiment;

FIGS. 7A-7B show different mini-slot configurations according to embodiments;

FIG. 8 shows a schematic diagram illustrating a configuration of aggregated slots according to an embodiment;

FIGS. 9A-9B show schematic diagrams illustrating configurations of aggregated slots using a common control information according to embodiments;

FIG. 10A shows a schematic representation of a symbol configuration according to an embodiment, the configuration having a slot aggregation using existing mini-slot constraints;

FIG. 10B shows a schematic representation of a symbol configuration according to an embodiment, that relates to temporally align with a reference of the slot;

FIG. 11 shows a schematic representation of an existing Rel-16 slot structure 224 with that is transmitted after the inventive advantageous LBT;

FIG. 12 shows a schematic block diagram of a mobile wireless communication network according to an embodiment;

FIG. 13 is a schematic representation of a wireless communication system including a transmitter, like a base station, and one or more receivers, like user devices, UEs; and

FIG. 14 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

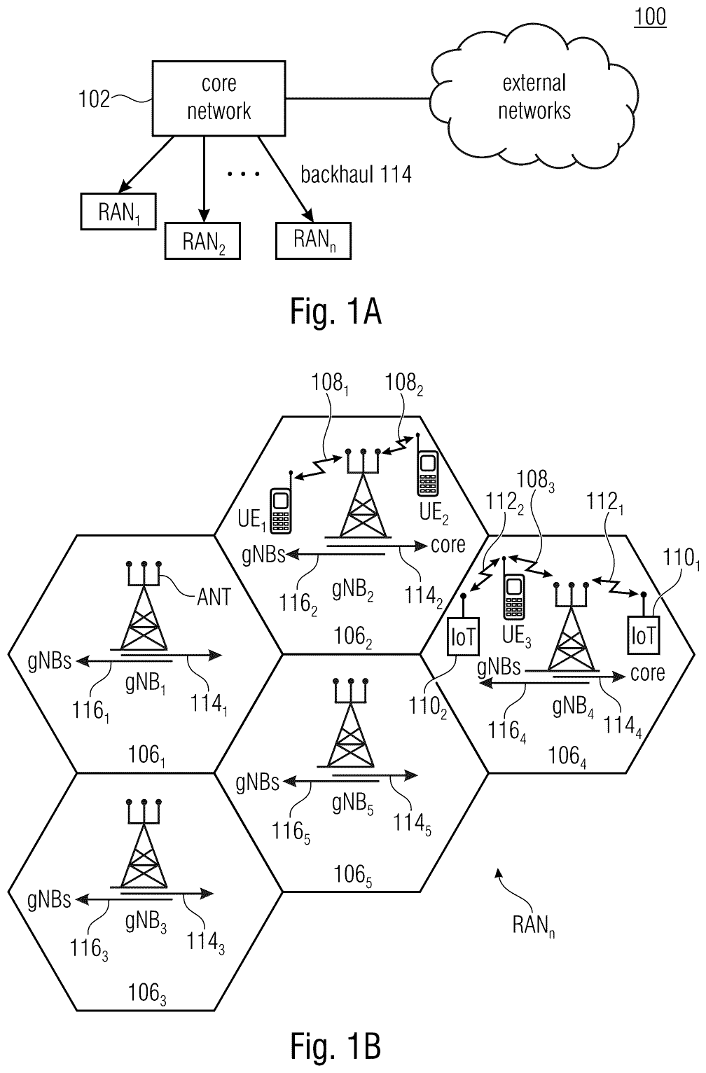

In mobile communication systems or networks, like those described above with reference to FIG. 1, for example in a LTE or 5G/NR network, the respective entities may communicate using one of more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier, a bandwidth part, BWP, a subband, or a subchannel and the like. Furthermore, only certain frequencies as in frequency interlaces or a frequency comb structure can be used, to utilize diversity in frequency domain, meaning that frequencies belonging to the same transmission need not be located in neighboring frequencies, but can be spread according to configured interlace structure within a channel or subchannel, subband, carrier or bandwidth part.

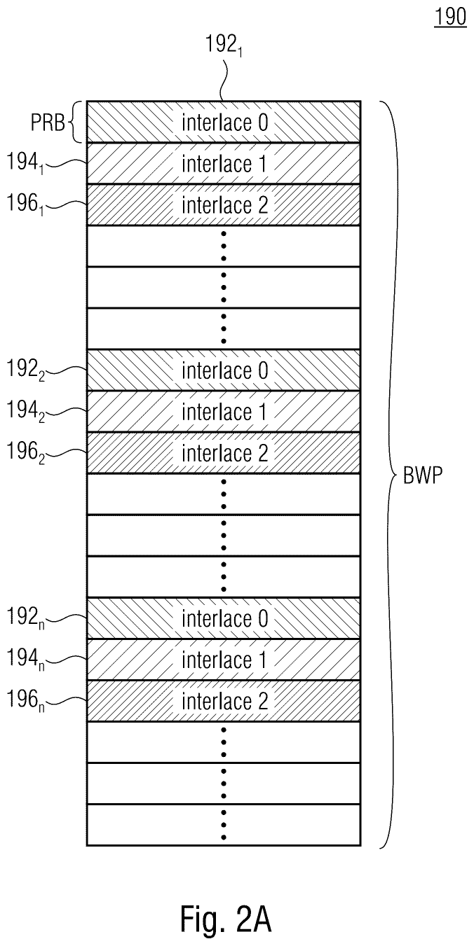

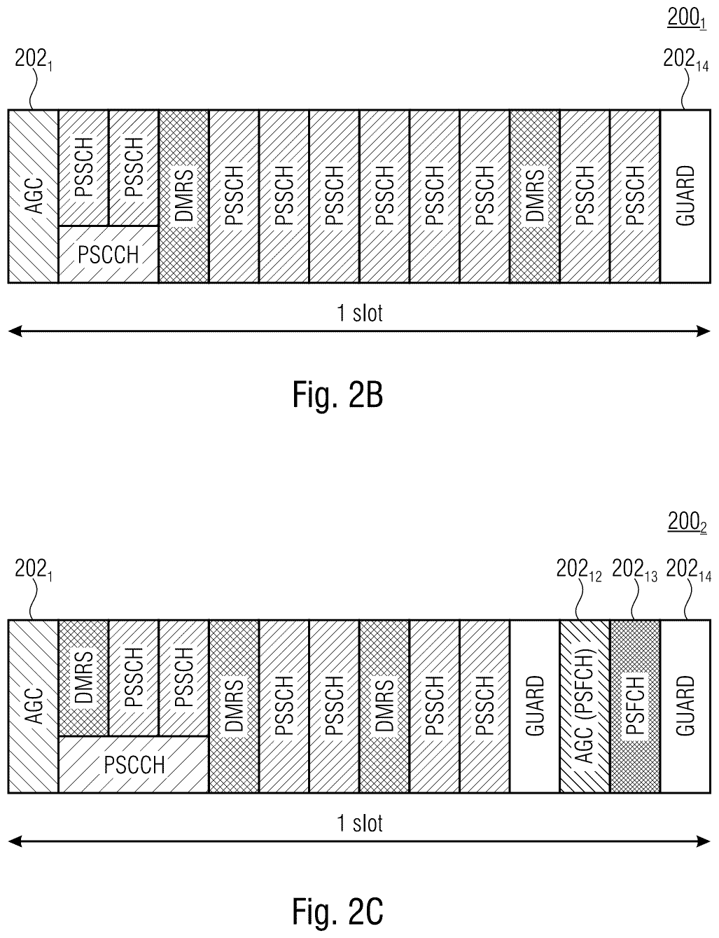

NR-U was designed to co-exist with other RATs such as IEEE 802.11, especially in the sub-6 GHz frequency bands. Due to this reason, NR-U supports only bandwidths that are an integer multiple of 20 MHz based on regulatory requirements, where each of these 20 MHz channels are designated as a subband. While NR-U supports both contiguous and interlaced resource allocation schemes, for interlaced resource allocation, the basic unit of resource allocation is called an interlace, consisting of a number of equally spaced resource blocks within the 20 MHz sub band. This is depicted in FIG. 2A showing a depiction of interlaces in NR-U by way of an illustration schematic of a bandwidthpart, BWP, 190 comprising a set of Physical Resource Blocks, PRBs, being grouped to interlaces 192₁, . . . , 192ₙ, 194₁, . . . , 194ₙ, 196₁, . . . , 196ₙ, wherein the number of PRBs of an interlace and a number of interlaces in a PRB may be freely selected.

A UE is hence configured with a parameter M denoting the number of interlaces, and multiple interlaces of resource blocks are defined, where each interlace consists of common resource blocks that are determined by {m, M+m, 2M+m, 3M+m, . . . }. The UE is then expected to perform an intersection operation with the resource blocks of the configured BWP. The number of interlaces are restricted to a maximum of 10.

When using a single frequency band, the communication may be referred to as a single-band operation, e.g., a UE transmits/receives radio signals to/from another network entity on frequencies being within the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum.

5G New Radio (NR) may support an operation in the unlicensed spectrum so that a multi-band operation may include frequency bands in the unlicensed spectrum bands. This may be referred to as NR-based access to unlicensed spectrum, NR-U, and the frequency bands may be referred to as subbands. The unlicensed spectrum may include bands with a potential IEEE 802.11 coexistence, such as the 5 GHz and the 6 GHz bands. NR-U may support bandwidths that are an integer multiple of 10 or 20 MHz, for example due to regulatory requirements. The splitting into the subbands is performed so as to minimize interference with coexisting systems, like IEE 802.11 systems, which may operate in one or more of the same bands with the same nominal bandwidth channels, like 10 or 20 MHz channels. Other examples of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands a channel access procedure is to be performed separately per subband, e.g., Listen-before-talk, LBT, or a request to send/clear to send mechanism, RTS/CTS mechanism. This may lead to a situation in which one or more of the subbands are busy or occupied due to an interference, for example, from other communication systems coexisting on the same band, like other public land mobile networks, PLMNs or systems operating in accordance with the IEEE 802.11 specification. In such a situation, the transmitter, either the transmitting gNB or the transmitting UE, is only allowed to transmit on the subbands which are detected to be not busy, also referred to as subbands being free or non-occupied, as is determined by the LBT algorithm. For example for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy or non-won subbands.

For example, the 5G New Radio (NR) technology supports operation in unlicensed bands through a technology referred to as NR-based access to unlicensed spectrum (NR-U). The unlicensed spectrum may include bands, e.g., with potential IEEE 802.11 coexistence, such as the 5 GHz and the 6 GHz bands. NR-U may support bandwidths that are an integer multiple of 10 or 20 MHz, for example due to regulatory requirements. Each of the 10 or 20 MHz bandwidth channels is designed as a subband, and the splitting into the subbands is performed so as to minimize interference with coexisting systems, like IEE 802.11 systems, which may operate in one or more of the same bands with the same nominal bandwidth channels, like 10 or 20 MHz channels. Other examples, of coexisting systems may use subbands having subband sizes and nominal frequencies different from the above-described IEEE 802.11 systems. For example, unlicensed subbands may be used, for example, the 24 GHz band or the 60 GHz band. Examples of such unlicensed subbands include the industrial, scientific and medical, ISM, radio bands reserved internationally for the use of radio frequency energy for industrial, scientific and medical purposes other than telecommunications.

In general, during a wideband operation using unlicensed subbands, for example a transmission spanning more than 20 MHz in the 5 GHz operational unlicensed band, the transmitter, like the gNB or the UE perform LBT separately on each subband, and once the LBT results are available for each subband, the devices, for example, the gNB in the downlink, DL, or the UE in the uplink, UL, are allowed to only transmit on those subbands which are determined to be free or unoccupied, i.e., to transmit on the won subband. For example, in the 5 GHz unlicensed band, the number of 20 MHz subbands used for a wideband operation may be four, so that the overall bandwidth is 80 MHz, however, the number of actually used subbands may differ.

When considering, for example, a NR unlicensed operation, NR-U, i.e., a multi-band communication using frequency bands or subbands in the unlicensed spectrum, a UE or a gNB may perform LBT to capture the channel for the channel occupancy time, COT. A COT may also be shared with other devices, for example, a UE may share a gNB-initiated COT, and the UE may use the gNB-initiated COT after a so-called switching gap. In case the gap exceeds a certain duration, for example, 16 μs, the other device may perform LBT, either CAT-2 or CAT-4, dependent on the duration of the gap. In a wideband operation, a UE or a gNB are supposed to perform LBT for each and every subband, and the total amount of subbands may comprise a complete bandwidth part, BWP.

When transmitting in a multi-band or wideband operation, a transport block, TB, is sent out by a transmitter. For example in case of a communication between a base station and a user device, the transmission may be a downlink transmission from the gNB to the UE or an uplink transmission from the UE to the gNB. In case of sidelink communications, the transmitter may be a UE for transmitting the transport block to a receiving UE over the sidelink. The receiver, the UE or the gNB, receives the TB and is to decode the data. A feedback mechanism, like the HARQ mechanism is implemented. The feedback mechanism may indicate or signal to the transmitter a successful or a non-successful transmission of the data, for example by sending an acknowledgement message, ACK, or a non-acknowledgement message, NACK. The feedback mechanism may indicate or signal to the transmitter that there is no need for redundancy for the data or that there is a need for some redundancy for the data. The feedback may also indicate of signal an amount of additional redundancy needed for the data. Responsive to the feedback, the transmitter, in case of a NACK, may perform a retransmission. For example, the retransmission may contain the same information, for example the same data and the same parity bits to allow chase combining at the receiver. The retransmission may also include incremental redundancy.

The TB may be split into a plurality of code block groups, CBGs, and the retransmission mechanism is to indicate the ACK/NACK and is to retransmit the data in the unit of CBG. A CBG may include one or more code blocks, CBs. Thus, when splitting the TB into multiple CBGs, a multiple code block group based HARQ may be used. When considering a multiband operation, the CBGs are confined to a respective frequency band or subband, and one or more CBGs may share the TB duration or the slot duration in a time division multiplex, TDMed, fashion.

Although referring herein to a UE as a device or apparatus that is in accordance with embodiments, said embodiments are not limited to UEs. Embodiments may be implemented, without limitation by other apparatus capable of communicating in mobile wireless communication networks, e.g., a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit (RSU), or a building, or any other item or device provided with network connectivity enabling the item/device to communicate using the wireless communication network, e.g., a sensor or actuator. Alternatively or in addition such a device or apparatus may comprise a base station, BS, wherein the BS is implemented as mobile or immobile base station and comprises one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

3GPP LTE Release 14 was the first LTE release to include vehicle-to-everything (V2X) techniques. The scheduling and assignment of resources have been modified according to the V2X requirements, while the original LTE device-to-device (D2D) communication mechanisms have been used as the basis of the design. 3GPPs LTE Release 15 (also known as enhanced V2X or eV2X) was completed in June 2018, and Release 16, was the first release of 5G NR V2X, which was completed in March 2020. 3GPPs NR Release 17 focuses on sidelink enhancements, with emphasis on power saving, enhanced reliability and reduced latency, to cater to not only vehicular communications, but also public safety and commercial use cases.

The current discussions for NR Release 18, e.g., RP-220300 to be found on https://www.3gpp.org/ftp/TSG_RAN/TSG_RAN/TSGR_95e/Docs/?sortby=size focus on implementing sidelink in the unlicensed spectrum (SL-U). This particular invention report deals with the frame structure that is to be used for SL-U while taking into account the resource pool structure from NR V2X as well as NR-U from Rel-16.

In order to understand the complexities behind the NR-U and NR V2X systems, this section delves into the working of NR-U Listen-Before-Talk, LBT and NR V2X frame structures.

### NR V2X Time Slot Formats

NR V2X UEs are configured with one active Sidelink Bandwidthpart, SL BWP, which is used for both transmissions and receptions. The SL BWP further contains resource pools, which is where the specific sidelink channels are transmitted and received over. The frame structure for time slots using the synchronization channel differs from those used for transmission/reception, and the time slots used for transmission/reception are what is relevant for this invention report.

These time slots contain the Physical Sidelink Control Channel PSCCH for control, the Physical Sidelink Shared Channel PSSCH for control/data, and additionally the Physical Sidelink Feedback Channel PSFCH for Hybrid Automated Repeat Request, HARQ, feedback, Automated Gain Control, AGC, symbols and guard symbols. The second SL symbol (containing the first PSCCH or PSCCH/PSSCH symbol) is duplicated in the first SL symbol that is used for AGC purposes. [Source: A Tutorial on 5G NR V2X Communications—Mate Boban et. Al.] Within the slots that can be used for PSSCH transmission, there can be from 7 to 14 of the symbols reserved for sidelink operation, of which PSSCH can be transmitted in 5 to 12 symbols. The remaining sidelink symbols transmit some or all of PSCCH, PSFCH, DMRS, AGC symbol(s) and guard symbol(s). Examples of time slots with and without the PSFCH configured can be seen in the slot configurations 200₁ and 200₂ illustrated in FIG. 2B and FIG. 2C that are taken from TR 37.985.

In the slot configuration 200₁ without PSFCH shown in FIG. 2B symbols 202₁ to 202₁₄ comprise symbols related to AGC, PSSCH, PSCCH, DMRS and Guard. In the slot configuration 200₂ with PSFCH shown in FIG. 2C, additionally, a PSFCH is contained in symbol 202₁₃ which may be copied and used as AGC in symbol 202₁₂.

All transmissions, and hence receptions, take place in a per slot basis. This means that a given Protocol Data Unit, PDU, is packed into being transmitted within a single time slot, which contains the control information in the form of Sidelink Control Information, SCI, format 2A within the PSCCH, followed by the 2nd stage SCI format 2B or 2C and the data, both within the PSSCH. Some time slots can be configured with PSFCH, while some need not, depending on the resource pool configurations. The UE uses a (pre-)configured time gap between the next possible and configured PSFCH time slot and the time a transmission was received in order to determine the time slot in which it would transmit the feedback for a given transmission.

### NR-U Frame Structures

NR frame structure supports Time Division Duplex, TDD, and Frequency Division Duplex, FDD, transmissions and operation in both licensed and unlicensed spectrum. The frame structure follows three key design principles to enhance forward compatibility and reduce interactions between different features.
The first principle is that transmissions are self-contained. Data in a slot and/or in a beam is decodable on its own without dependency on other slots and/or beams.
The second principle is that transmissions are well-confined in time and frequency. NR frame structure avoids the mapping of control channels across the full system bandwidth.
The third principle is to avoid static and/or strict timing relations across slots and across different transmission directions.

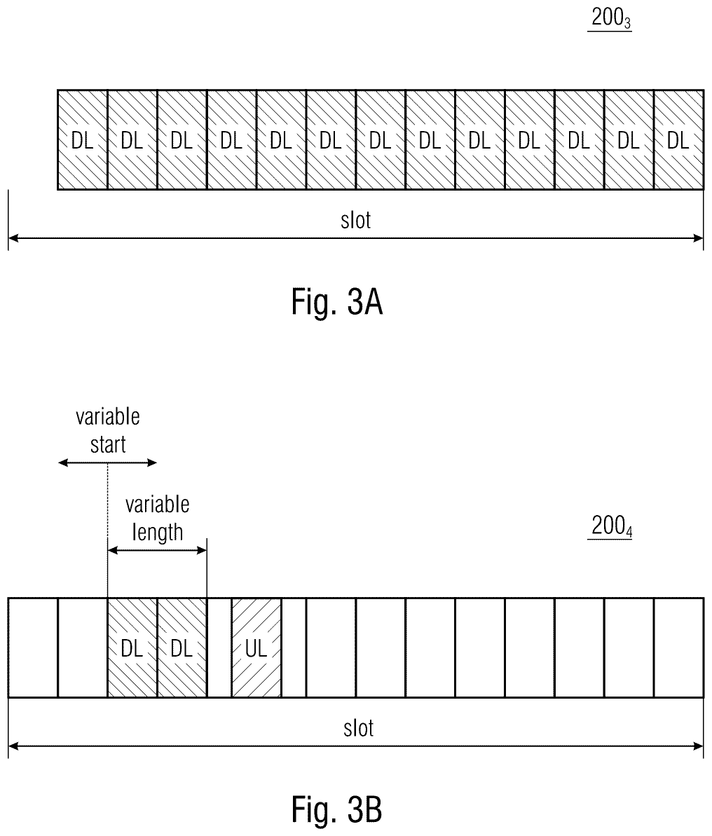

A slot in NR comprises seven or 14 OFDM symbols for s 60 kHz numerologies and 14 OFDM symbols for 120 kHz numerologies. A slot duration also scales with the chosen numerology since the OFDM symbol duration is inversely proportional to its subcarrier spacing (SCS). A slot can be complemented by mini-slots to support transmissions with a flexible start position and a duration shorter than a regular slot duration. A mini-slot can be as short as one OFDM symbol and can start at any time. Mini-slots can be useful in various scenarios, specifically for transmissions in unlicensed spectrum due to the need to incorporate the use of LBT at the beginning of the time slot. When transmitting in unlicensed spectrum, it is beneficial to start transmissions immediately after LBT since the transmission needs to begin immediately without waiting for the start of a slot boundary in order to avoid interference with other users or other technologies. FIG. 3A and FIG. 3B provide examples of LBT-based transmission in unlicensed spectrum via mini-slots. [Source: https://www.ericsson.com/en/reports-and-papers/ericsson-technology-review/articles/designing-for-the-future-the-5g-nr-physical-layer]

The new frame structure type 3 was introduced by 3GPP for operations in the unlicensed communications channels. Similar to the LTE TDD, the uplink and downlink operations using frame structure type 3 are on the same frequency channel but are separated in time. However, unlike in LTE TDD, a subframe is not configured as a downlink subframe or an uplink subframe and may be used by either the base station or the wireless device. [Source: https://ofinno.com/technologies/new-radio-unlicensed-band/]

### Listen-Before-Talk—LBT

In NR-U, channel access in both downlink and uplink rely on the listen-before-talk (LBT) feature. A wireless device or a base station first “senses” the communications channel to find out there is no communications prior to any transmission. When a communication channel is a wide bandwidth unlicensed carrier (e.g., several hundred MHz), the “channel sensing” procedure relies on detecting the energy level on multiple sub-bands of the communications channel.

After contending for k idle slots on the channel, a device can use the channel for a time period referred to as channel occupancy time (COT). Note, that the definition of a time slot in NR and WiFi® system is different. In NR, a time slot consists of 14 (normal cyclic prefix) or 12 (extended cyclic prefix) OFDM symbols. The length of an OFDM symbol for the standard numerology with 15 kHz subcarrier spacing (SCS) is typically 71.4 μs, and with 30 kHz SCS is 35.7 μs. Furthermore, NR defines a concept called mini-slots, which can occupy 2, 4 or 7 OFDM symbols, which enables non-slot based scheduling. “Non-slot” typically groups a number of OFDM symbols together, which add up to less than a defined and typically used slot length. In WiFi® systems, the time reference is referred to as “slot time”, which in more recent WiFi® specifications, e.g., IEEE 802.11g/n/ac, is defined as 9 μs.

The LBT parameters (such as type/duration, clear channel assessment parameters, etc.) are configured in a wireless device by the base station. [Source: https://ofinno.com/technologies/new-radio-unlicensed-band/]
Type 2 LBTs can only be performed within an already started COT. So for COT initiation the UE always has to perform type 1 LBT. [Source: TS37.213 Section 4.2.1]
Type 1 LBT has a minimum duration of 34 μs
Type 2 LBT can only be performed if a COT-initiating UE is indicating to share its COT with another UE
Type 2A is 25 μs
Type2 B is16 μs
Type 2 C is LBT-less (transmission duration at most 584 μs and gap at max 16 μs)
Maximum Contention Window, CW, for priority 4 ranges from 15 to 1023 sensing slots, or 135 to 9207 μs, or 4 to 256 time slots with 30 kHz SCS
Wide-band LBT: UE performs Type 1 LBT on one band and Type 2 on the other bands
Transmit on free bands if intra-cell guard bands are configured

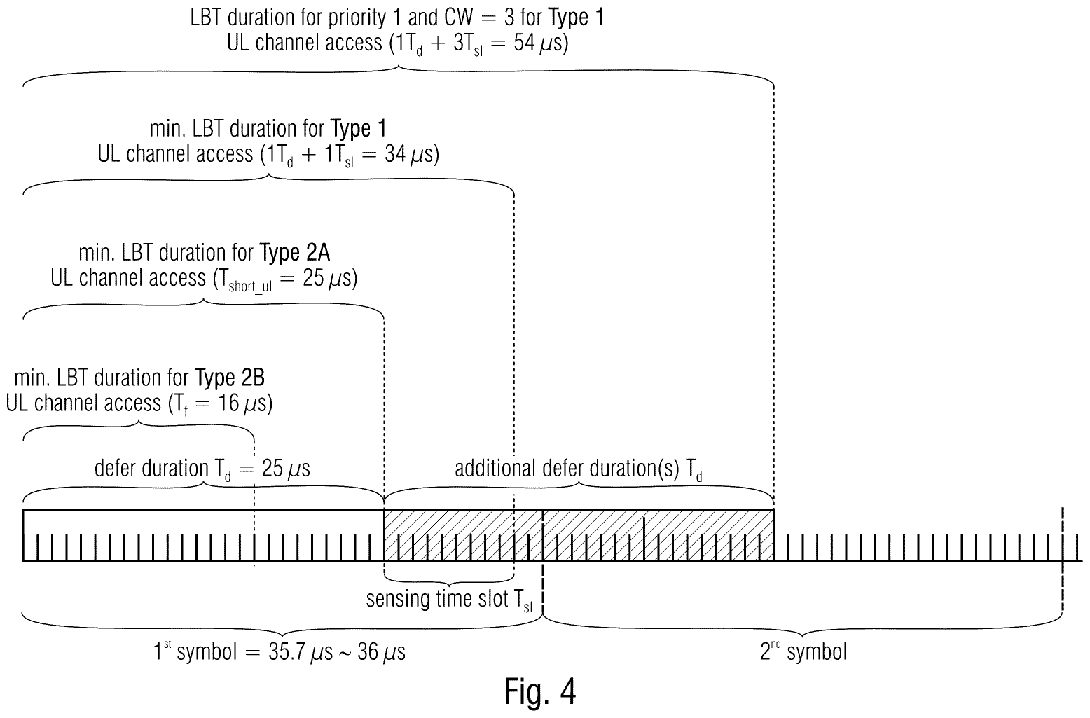

The procedures for the channel access are described in the following sections, with the timeline depicted in FIG. 4 illustrating a Channel Access Timeline Depiction per 3GPP time slots definition.

### NR-U Channel Access Procedures

A channel access procedure is a procedure based on sensing that evaluates the availability of a channel for performing transmissions. The basic unit for sensing is a sensing slot with a duration Tₛᵢ=9 μs. The sensing slot duration Tₛᵢ is considered to be idle if an eNB/gNB or a UE senses the channel during the sensing slot duration, and determines that the detected power for at least 4 μs within the sensing slot duration is less than energy detection threshold X_{Thresh}. Otherwise, the sensing slot duration Tₛᵢ is considered to be busy.

A channel occupancy refers to transmission(s) on channel(s) by eNB/gNB/UE(s) after performing the corresponding channel access procedures in this clause.

A channel occupancy time (COT) refers to the total time for which eNB/gNB/UE and any eNB/gNB/UE(s) sharing the channel occupancy perform transmission(s) on a channel after an eNB/gNB/UE performs the corresponding channel access procedures described above. For determining a Channel Occupancy Time, if a transmission gap is less than or equal to 25 μs, the gap duration is counted in the channel occupancy time. A channel occupancy time can be shared for transmission between an eNB/gNB and the corresponding UE(s).

### Type 1 Uplink, UL, Channel Access Procedure

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
Step 1) set N=Nᵢₙᵢₜ, where Nᵢₙᵢₜ is a random number uniformly distributed between 0 and CWₚ, and go to step 4;
Step 2) if N>0 and the eNB/gNB chooses to decrement the counter, set N=N−1;
Step 3) sense the channel for an additional sensing slot duration, and if the additional sensing slot duration is idle, go to step 4; else, go to step 5;
Step 4) if N=0, stop; else, go to step 2.
Step 5) sense the channel until either a busy sensing slot is detected within an additional defer duration T_{d} or all the sensing slots of the additional defer duration T_{d} are detected to be idle;
Step 6) if the channel is sensed to be idle during all the sensing slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 μs immediately followed by mₚ consecutive slot durations where each slot duration is Tₛₗ=9 μs, and T_{f} includes an idle slot duration Tₛₗ at start of T_{f}.

### Type 2A UL Channel Access Procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_ul}=25 μs. T_{short_ul} consists of a duration T_{f}=16 μs immediately followed by one sensing slot and T_{f} includes a sensing slot at start of T_{f}. The channel is considered to be idle for T_{short_ul} if both sensing slots of T_{short_ul} are sensed to be idle.

### Type 2B UL Channel Access Procedure

If a UE is indicated to perform Type 2B UL channel access procedures, the UE uses Type 2B UL channel access procedure for a UL transmission. The UE may transmit the transmission immediately after sensing the channel to be idle within a duration of T_{f}=16 μs. T_{f} includes a sensing slot that occurs within the last 9 μs of T_{f}. The channel is considered to be idle within the duration T_{f} if the channel is sensed to be idle for total of at least 5 μs with at least 4 μs of sensing occurring in the sensing slot.

### 2C UL Channel Access Procedure

If a UE is indicated to perform Type 2C UL channel access procedures for a UL transmission, the UE does not sense the channel before the transmission. The duration of the corresponding UL transmission is at most 584 μs.

### Slot Formats for NR-U

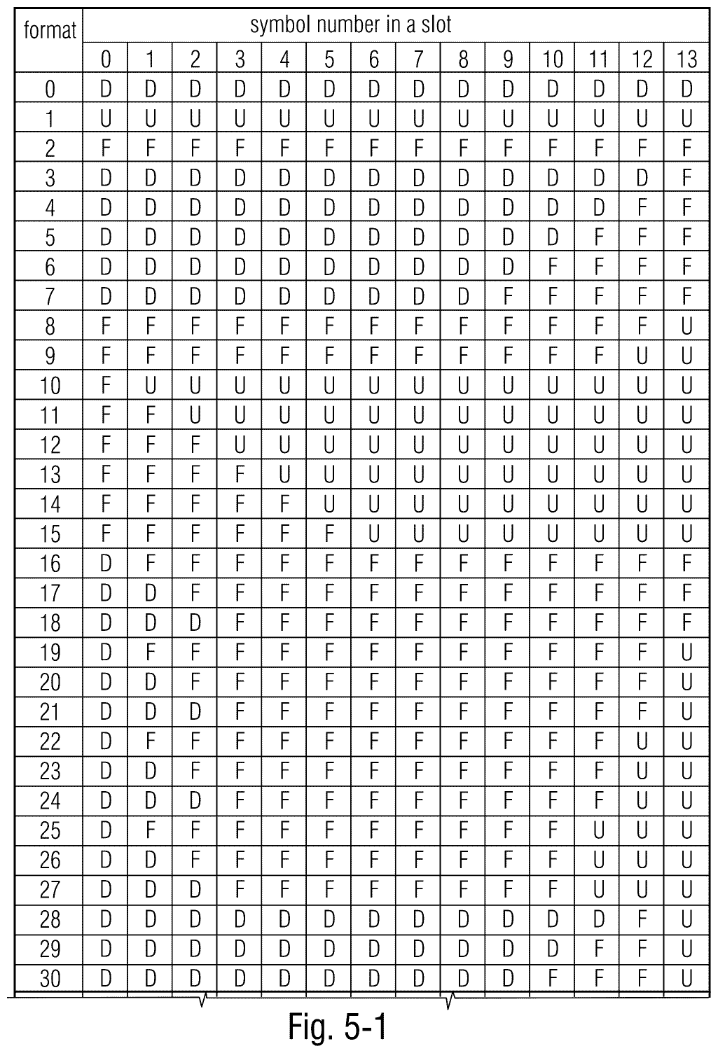

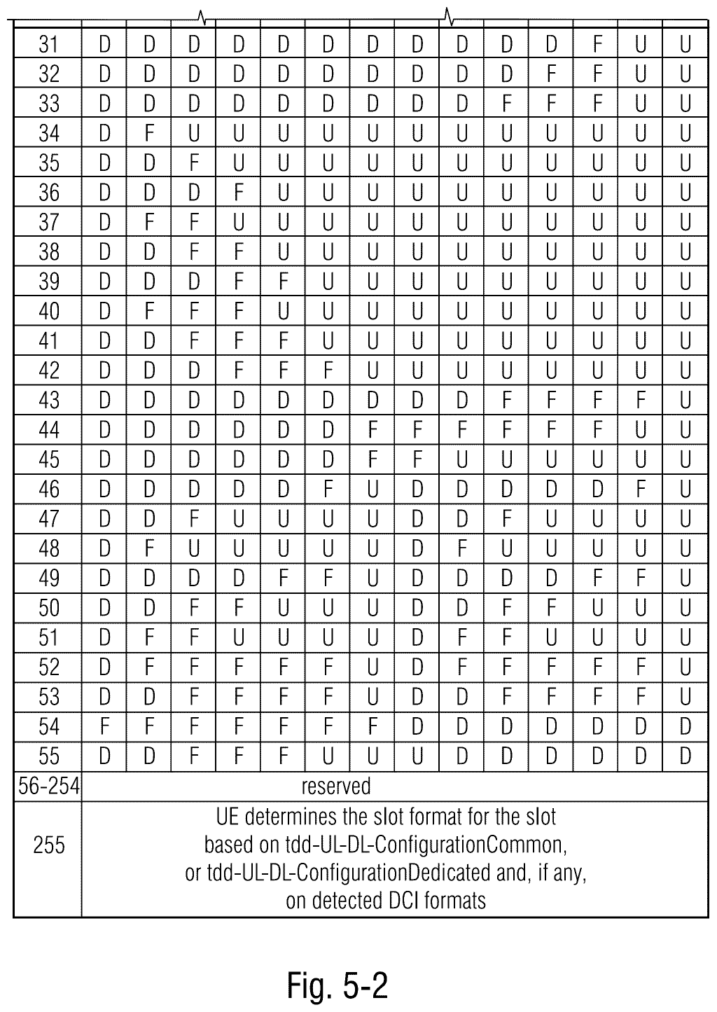

FIG. 5 shows an example table of slot formats for normal cyclic prefix as defined in Table 11.1.1-1 of TS38.213, Section 11.1.1.

The inventors have identified three main issues or problems in terms of implementing unlicensed procedures over the sidelink, predominantly dealing with the fact that LBT in NR-U occurs in a per-symbol basis, while NR V2X operates in a per-slot basis:

Problem 1: Since NR V2X uses a per-slot basis transmission, if LBT were to determine that a few symbols in the beginning of a time slot are available, the UE cannot start transmitting in the same time slot due to the per-slot basis transmission restriction. It can only transmit in the following slot, but the LBT check does not contain any information regarding the following slot's availability, only for the current symbols in a slot.

Problem 2: If LBT can be adapted for use in SL-U, the criteria and actions that the UE has to employ in order to handle LBT failures have to be adopted based on NR V2X.

To solve technical problems related to LBT in NR, especially in connection with V2X, the inventors propose a set of solutions.

### Proposed Technical Solutions

The inventors propose to combine LBT and data transmission within one slot regardless whether the device, e.g., a UE or a base station operates on a slot basis or a symbol basis.

Solutions described herein can be applied to a system that contains only 3GPP devices or UEs, e.g., LTE UEs and NR UEs, as well as to systems that contain 3GPP devices/UEs along with non-3GPP UEs, e.g., NR UEs and WiFi or Bluetooth devices. Furthermore, the gNB or another UE may inform one or more other UEs about the presence or absence of such devices, e.g., using the absenceOfAnyOtherTechnology flag within the ServingCellConfig information element, see an example from the TS38.331 (3GPP TS 38.331 version 16.7.0 Release 16):
absenceOfAnyOtherTechnology
   Presence of this field indicates absence on a long term basis (e.g. by level of regulation) of any other technology sharing the carrier; absence of this field indicates the potential presence of any other technology sharing the carrier, as specified in TS 37.213 [48] clauses 4.2.1 and 4.2.3.

In addition, it could be signaled to the UE that a certain RAT or a certain non-3GPP RAT is present or absent, using flags like absenceOfNon3GPPTechnology, presenceOfWiFiTechnology, etc.

Depending on the presence or absence of such fields, different solutions described in this invention could be triggered, enabled or disabled, e.g., a mini-slots with slot aggregation can be used in a system with no non-3GPP devices present.

### Idea 1: Flexible Transmission Slot Structures

Problem 1: Since NR V2X uses a per-slot basis transmission, if LBT were to determine that a few symbols in the beginning of a time slot are available, the UE cannot start transmitting in the same time slot due to the per-slot basis transmission restriction. It can only transmit in the following slot, but the LBT check does not contain any information regarding the following slot's availability, only for the current symbols in a slot.

### Solution 1: Use (Pre-)Configured or (Pre-)Defined Mini-Slot Structures

### Solution 1-1 of Idea 1

Solution 1-1 is to introduce (pre-)configured or (pre-)defined mini-slot structures. The slot structures that are allowed for NR-U are listed in TS38.213 Section 11.1.1.

The UE will carry out sensing for the initial resource selection, and a combination of sensing and re-evaluation for the reserved resources based on the initial transmission, similar to Rel-16. Before transmitting in a selected resource, embodiments provide for devices, e.g., a UE that will perform LBT over the first symbols of a time slot. In other words, the UE will follow the Rel-16 or Rel-17 slot boundary for the LBT procedure.

Once the UE completes the LBT and ascertains that the subchannel is available, it would have already taken up at least 1-2 symbols. But the current slot structure would not allow a UE to transmit in between a time slot. Hence, we propose that we use new mini-slots of varying symbol lengths for using the remainder of the symbols in a time slot after carrying out LBT (with each remaining symbol meant for TX). Each mini-slot can have a small number of symbols, e.g., 2-3 symbols, for the PSCCH and the remaining number of symbols for data and/or feedback and/or pilot symbols, e.g., DMRS.

By taking into account the slot structures that are present in TS38.213 for NR-U, we propose that the DL and UL symbols within a time slot can be replaced by TX and RX symbols. This will define the symbols within a time slot that a UE can receive/sense/carry out LBT and once determined that the channel is available, the UE can use the remaining symbols to transmit. Furthermore, the following specifics can be applied for the new slot structure, each alone or in combination with one or more others:
Each of the time slot structures can have a minimum of 1 symbol for LBT and a maximum of 14 symbols of a slot for LBT alone. This would mean that the LBT symbols are denoted by receive, R.
The symbols that the UE will use for transmission of the PSCCH, PSSCH, AGC and DMRS are denoted by T, whilst some slots allow for a flexible use indicated by F.
Each time slot can have the LBT (R) symbols in the beginning, followed by the transmission symbols (T). If the time slot supports the reception of PSFCH, then few symbols at the end of the time slot should also be denoted by R.
The table presented in FIG. 5 can be extended since it has only 55 values defined from a possible 254. The reserved format indices, e.g. 56-254, can be used to define the time slot structures for SL unlicensed as described above.

Hence if the UE has carried out LBT for the first 3 symbols, the UE can use the remaining symbols to transmit control and data on the subchannel, in the form of the mini-slot structure which includes PSCCH, PSSCH and Demodulation Reference Symbol, DRMS. The mini-slot may also begin with an AGC symbol and end with a guard symbol.

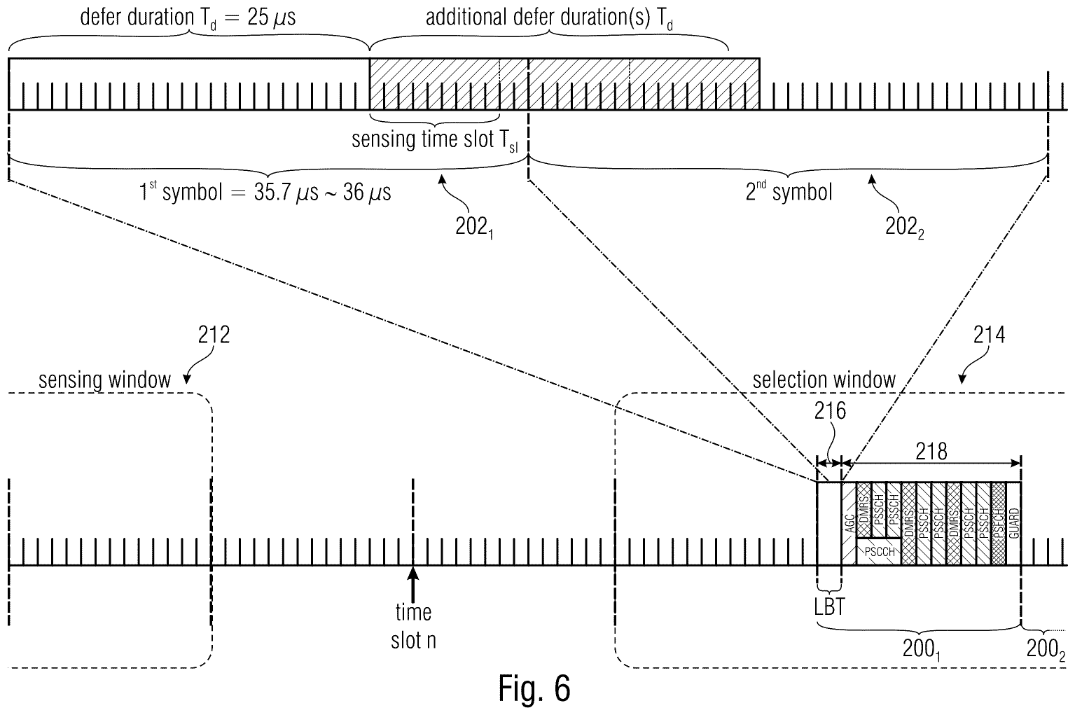

An procedure of combining LBT with transmitting symbols in a slot is presented in FIG. 6. After having possibly sensed the sidelink or the channel during a sensing window 212 and after having performed selection of further resources, a device can aim to transmit during a selection window 214, more particular slot 200₁. The device is configured for performing LBT during a first time interval 216 of slot 200₁. The time interval 216 may comprise or correspond to, by way of non-limiting example, a duration of symbols 202₁ and 202₂. The time interval 216 may last at least one symbol. An upper limit of the first time interval may be within slot 200₁, wherein embodiments also cover implementations where the LBT procedure extends the slot boundary. For example, in accordance with ETSI BRAN, LBT may be performed for up to 256 time slots, e.g., with 30 kHz SCS, which technically means that according to embodiments a full time slot, more than a time slot or a number of time slots can be used for LBT.

After having determined an availability of slot 200₁ or the slot or symbol following the first time interval 216 the device may start its transmission in a second time interval 218. For transmission, according to one embodiment, the device may use a remaining part of slot 200₁ and/or at least a part of a subsequent slot 200₂.

According to an embodiment, an apparatus configured for communicating in a mobile wireless communication network, the apparatus comprising a wireless interface for transceiving wireless signals in the mobile wireless communication network; is configured for
communicating over a sidelink, SL, in the mobile wireless communication system, the sidelink providing for a plurality of time slots, each time slot having a slot duration,
wherein the apparatus is configured for using at least a first time interval of the slot duration, to perform a listen-before-talk, LBT, procedure to determine an availability of the time slot; and to use a second time interval of the slot duration for a wireless transmission based on the determined availability; and/or
wherein the apparatus is configured for using at least a first slot duration, to perform a listen-before-talk, LBT, procedure to determine an availability of at least a part of a later second time slot, e.g., the slot, a mini-slot or a mini-frame, and/or to use the at least part of the later second time slot for a wireless transmission based on the determined availability.

According to an embodiment, the apparatus is configured for communicating in the mobile wireless communication network on one or more of the following:
a basis of time slots, where each time slots consist of a plurality of symbols across time,
a basis of symbols, where each symbol is associated with a defined symbol duration of time depending on the sub carrier spacing used for the resource pool,
a basis of a configured or preconfigured set of symbols.

According to an embodiment, the apparatus is configured for using the second time interval at least as a remainder of the slot duration after the first time interval, i.e., the second time interval may end at, fall short from or extend beyond the slot boundary.

According to an embodiment, the apparatus is configured for transmitting a mini-frame in the second time interval that comprises a reduced number of symbols when compared to a capacity of a time slot of the mobile wireless communication network. In NR, a frame may consist of multiple time slots depending on the SCS. For 30 kHz SCS, a frame may have 10 subframes, and each subframe may comprise 2 slots (for 15 kHz, only 1 slot), and each slot may comprise 14 symbols. A mini-slot may be understood as a time slot with less than 14 symbols, 3GPP has defined their sizes as 2, 4 and 7 symbols for a mini-slot. Hence, a frame can comprise of one or more slots or mini-slots, and a mini-frame can be one or more mini-slots.

According to an embodiment, the capacity of a time slot corresponds to a frame that comprises of one or more time slots; wherein a time slot comprises of one or more symbols; wherein the mini-frame comprises of one or more mini-slots; wherein a mini-slot or mini-frame consists of one or more symbols; wherein the number of symbols are less than that of the number of symbols in a time slot.

According to an embodiment, a mini-frame contains on or more of:
less OFDM symbols than the capacity of the time slot,
any number of OFDM symbols from the set {1 . . . 13},
other mini-frames, where the total number of OFDM symbols does not exceed a slot boundary,
a combination of a plurality of mini-frames to form a new, longer mini-frame.

According to an embodiment, the apparatus is configured for temporally aligning an end of the second time interval with an end of a time slot of the mobile wireless communication network.

According to an embodiment, the apparatus is configured or preconfigured to transmit in one or more channels or sub-channels across frequency in the second time interval.

According to an embodiment, the sub-channels comprises one or more resource blocks across frequency, and/or
wherein the channels or sub-channels are defined within one or more resource pools, and/or
wherein the subbands are defined within a bandwidth part;
wherein each channel, subchannel or subband comprises of one or more contiguous or non-contiguous resource blocks.

According to an embodiment, the frequency resources are interlaced according to a configured or preconfigured scheme.

According to an embodiment, according to a configuration of the mobile wireless communication network, the slot duration comprises a number of symbol durations; wherein the apparatus is configured for performing LBT during a first subset of symbol durations; and for transmitting a number of symbols of the wireless transmission during a second subset of symbol durations.

According to an embodiment, the apparatus is configured for carrying out sensing prior to perform LBT to determine a resource to be used for a transmission and/or for an initial transmission and/or to determine one or more future reserved resources, which is subject to re-evaluation, to be used for retransmissions,
wherein the apparatus is configured to perform LBT to determine the availability of the resource for the transmission and/or the initial transmission and/or the one or more future reserved resources before the wireless transmission.

According to an embodiment, based on the determined availability of the time slot the apparatus is configured for using a temporal first symbol duration after the first time interval for transmitting a symbol of the wireless transmission. As a temporal first symbol one may understand the very first symbol that follows the last symbol used for LBT.

According to an embodiment, the apparatus is configured for using a predefined number of symbols, e.g., 2 or 3 symbols, of the second time interval for transmitting control information, e.g., associated with a Physical Sidelink Control Channel, PSCCH.

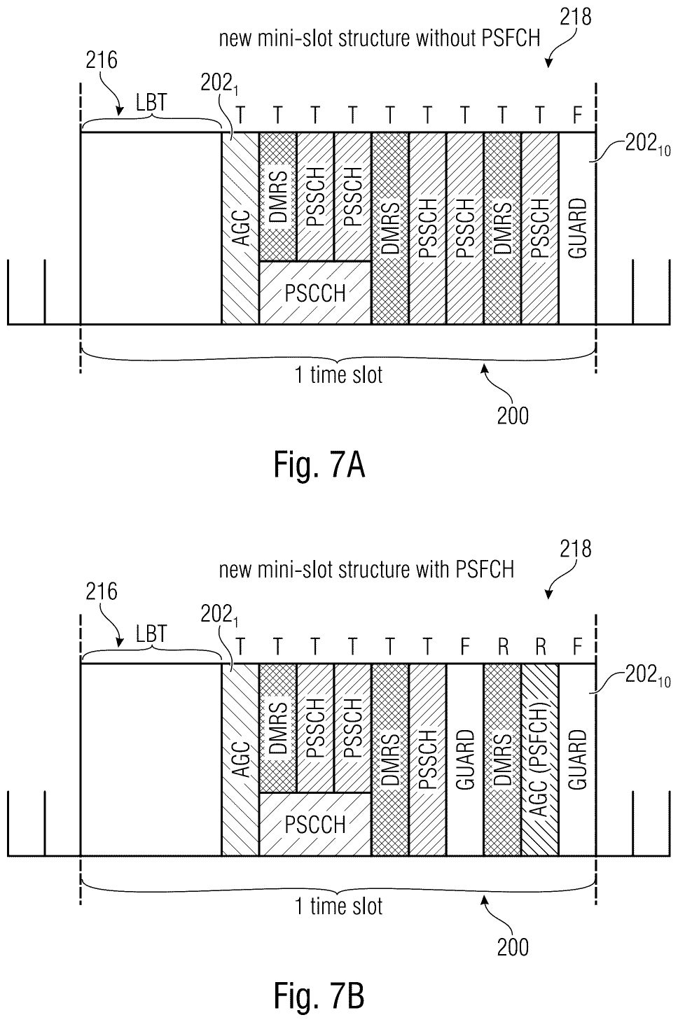

As described in connection with FIG. 7A and FIG. 7B, the second time interval 218 may be used for transmitting different symbols 202 according to different configurations.

According to an embodiment, the apparatus is configured for using, from remaining symbols of the second time interval 218 to transmit in at least one or more symbols one or more of:
a control channel, e.g., via PSCCH
a data channel, e.g., via PSSCH,
a broadcast channel, e.g., via PSBCH,
a feedback channel, e.g., PSFCH,
a pilot symbol, e.g., via DMRS,
a copied symbol (copy of a previous symbol), e.g., to be used for AGC tuning,
a guard symbol.

According to an embodiment, the apparatus is configured for transmitting the AGC symbol at a beginning of the second time interval and/or the guard symbol at an end of the second time interval.

According to an embodiment, the apparatus is configured for transmitting the control information at a predefined position in the second time interval, e.g., during the first 2 or 3 symbols after the AGC symbol.

According to an embodiment, the apparatus is configured for using at least one symbol duration for LBT and at most 14 symbol durations for LBT within the first time interval of the time slot. However, other configurations are also possible.

According to an embodiment, the apparatus is configured for using symbol durations of at least two different slots for LBT. For example, prior to transmitting, more than one slot may be occupied or reserved

According to an embodiment, the apparatus is configured for selecting a duration of the first time interval based on a random value between a minimum time duration and a maximum time duration.

According to an embodiment, the minimum time duration and/or the maximum time duration is based on a priority class of the wireless transmission.

Alternatively or in addition, according to an embodiment, the minimum time duration and/or the maximum time duration is based on one or more of the following aspects of the wireless transmission:
a cast type,
remaining PDB,
whether HARQ feedback is enabled/disabled for the transmission,
distance between the transmitting and receiving apparatus.

The device, e.g., UE or other apparatus can also use slot structures that allow it to include PSFCH symbol(s) and required guard symbols at the end of the time slot, in order to receive feedback for previous transmissions, such that a transmission requiring feedback (unicast/groupcast) can use the mini-slots with PSFCH enabled, while broadcast transmissions can use the mini-slot structures with PSFCH disabled. Guard symbols are practically empty symbols which are used for switching between transmission and reception or vice versa.

Problems with this solution:
More SL slot structures need to be defined, depending on the varying CW lengths, which would be different from the slot structures used in Rel-16/Rel-17. This would also result in a smaller amount of data transmitted in a time slot due to the lower number of PSSCH symbols included in a time slot.
Another issue is that the sensing procedure in Rel-16/Rel-17 relies on the PSCCH to be located within the first 2-3 symbols of a slot, after the AGC. If multiple such slot structures were to be introduced, the UE would be expected to look for the PSCCH across all the symbols of a time slot, increasing the power usage for the UE to carry out sensing.

### Solution 1-2 of Idea 1

Solution 1-2 Relates to Use Solution 1-1 in Combination with Slot Aggregation in Order to overcome the first issue of not being able to have enough symbols for transmission. This may comprise of “equalizing” the start or end of transmissions to terminate or begin at the slot boundary, so that a subsequent transmissions can begin at a slot boundary and such that all resource are used efficiently. The second aggregated slot can contain the same PSCCH contents as the first mini-slot that was transmitted after carrying out LBT.

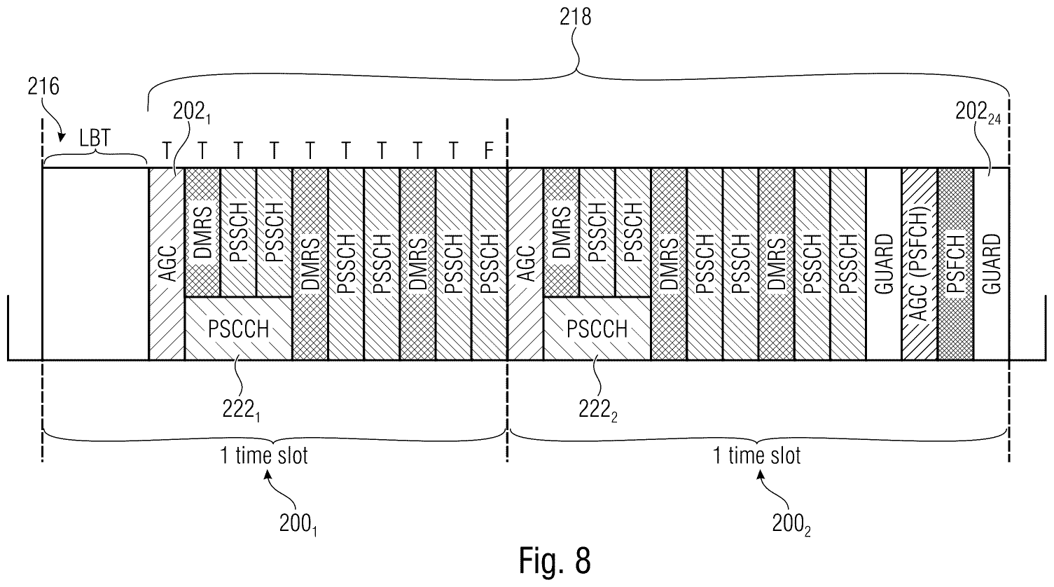

As shown in FIG. 8, the second time interval 218 may extend from a first slot 200₁ during which at least a part of the first time interval 216 is arranged and, thus, used for LBT, to at least another aggregated slot 200₂. The number of aggregated slots may be 2 as shown in FIG. 8 but may also be a larger number, e.g., 2, 3, 4, 5 or more, e.g., 254.

A configuration or use of symbols 202₁ to 202₂₄ contained in the second time interval 218 may be dynamic, static, preconfigured or configured. As indicated in FIG. 8, a PSCCH 222₁ and 222₂ may be transmitted during each aggregated slot 200₁ and 200₂. However, based on a variable length of time interval 216, the position of the PSCCH 222₁ may vary which may make it difficult to decode the PSCCH at a receiver. To address this, one possible solution is to remove the PSCCH 222₁ of slot 200₁ and to insert the required information in PSCCH 222₂ which may be located at a position known at the receiver.

This may mean that the PSCCH from the second time slot may inform the sensing UE about the usual reservation information, although it is not the intended recipient UE of the transmission. This would solve the second issue of the PSCCH being located in the first 2-3 symbols, albeit not of the first mini-slot, but at least of the second aggregated slot. The control information can include that the previous slot was also used for transmitting a mini-slot, so that the sensing UE is aware of the unavailability of the resource.

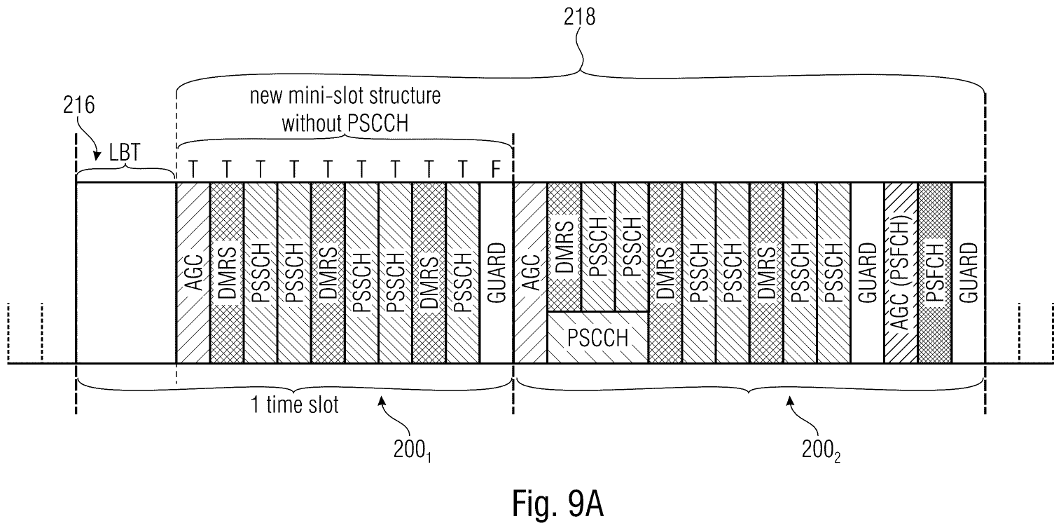

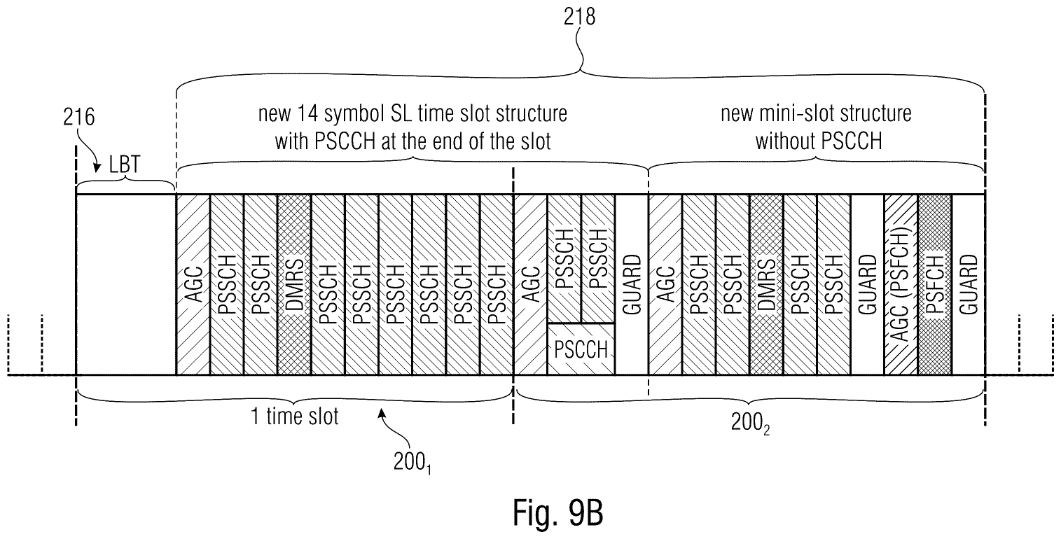

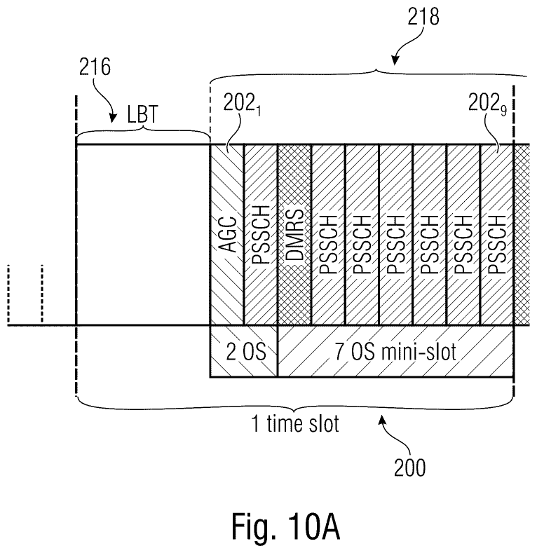

Another variant of this solution with slot aggregation is to remove control and/or feedback channel from the slot having a reduced number of symbols, which is depicted in FIG. 9A or FIG. 9B. Here, the PSCCH and/or PSFCH is only carried in the 2^{nd} time slot. Furthermore, the PSCCH within the 2^{nd} time slot could have a back reference indicating the type of mini-slot frame structure used in the 1^{st} time slot. The type defines how many symbols and which symbols carry one or more of AGC, DMRS, PSFCH, PSSCH, PSCCH, and/or guard symbols.

This new indication may indirectly signal that both time slots belong together such that a UE decoding the 2^{nd} time slot would also extract data within the 1^{st} time slot from its receive buffer, and decode the data either independently or together with the data form the 2^{nd} time slot. In this way, a shortened time slot may efficiently be combined with the existing time slot structure.

Note: this non-slot based or shortened frame structure, also allows a different frame structure in the 1^{st} time slot, e.g., containing the PSCCH, or a new type of PSCCH, and/or a PSFCH. Furthermore, the non-slot based part within the 1^{st} time slot may also be confined to only occupy 2, 4 or 7 OFDM symbols, e.g., to be in line with the existing mini-slot frame structure defined in NR. These mini-slot structures can contain one or more of PSCCH, PSSCH, PSFCH, DMRS, AGC, and/or guard symbols.

As shown in FIG. 9A, when using aggregated slots, the apparatus may use, in the first slot carrying transmission of second time interval 218, a mini-slot structure, e.g., without a PSCCH or, as an alternative, with PSCCH as shown in FIG. 8. Thereby the subsequent symbols may be temporally aligned with the slot structure. However, the alignment itself and in particular the alignment of the first slot is one possible solution.

As shown in FIG. 9B, the second time interval 218 may start with symbols according to a regular slot, e.g., comprising 14 symbols, regardless whether a PSCCH is inserted or not. A mini-slot may be optionally be used before an end of the transmission to temporally align with a slot boundary. The location of such a mini slot may be, for example, a second, third, . . . or last slot used for transmission.

An SCI can be transmitted in the mini-slot part of the frame within the PSSCH, similar to the 2^{nd}-stage SCI, immediately after the LBT. This SCI could be a further 2^{nd}-stage SCI or a 3^{rd}-stage SCI, or a conventional 2^{nd}-stage SCI which is transmitted prior to the 1^{st}-stage SCI. This enables receiving/sensing UEs to be aware of the presence of an aggregated slot which would contain the PSCCH. Furthermore, this may also implicitly configure the UE not to flush the buffer containing the mini-slots. The corresponding 1^{st}-stage SCI would be located within the 2^{nd} time slot in the PSCCH.

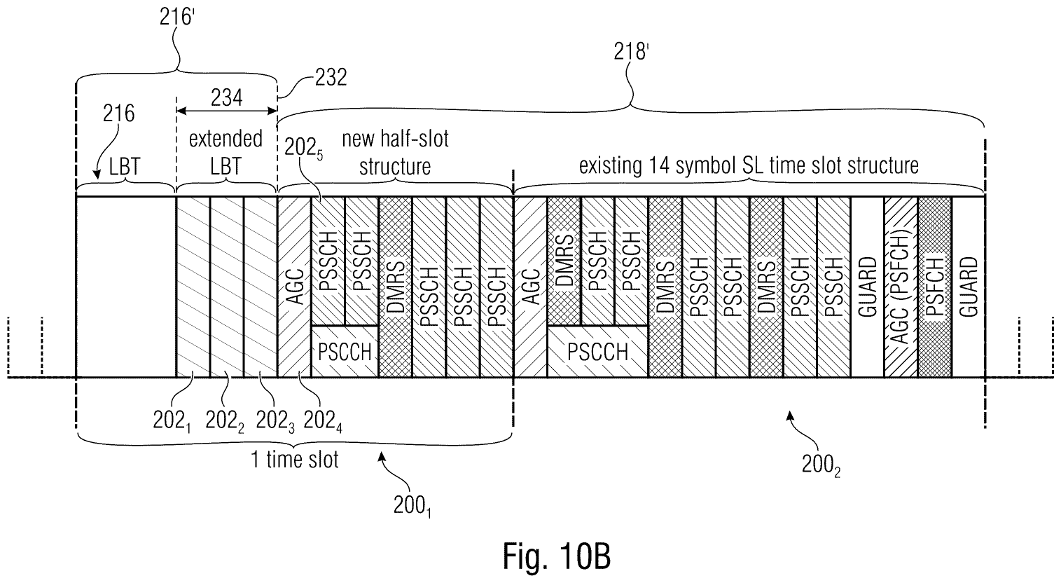

FIG. 10A shows a schematic representation of a symbol configuration having a slot aggregation using existing mini-slot constraints. OS indicates an OFDM Symbol. Here, the LBT is done over 4 OS, the transmission uses the remaining 2+7=9 OS 202₁ to 202₉.

In accordance with the described solution, the apparatus may be configured for aggregating the first time slot and at least one second time slot to an aggregated set of time slots and for using the second time slot in combination with the second time interval of the first time slot for transmissions.

According to an embodiment, the apparatus is configured for performing the LBT commonly for the aggregated set of time slots within the first time interval of the first time slot.

According to an embodiment, the apparatus is configured for temporally aligning an end of the transmitted symbols with an end of a time slot according to the slot basis of the mobile wireless communication network.

According to an embodiment, the apparatus is configured for transmitting a plurality of slots or frames during the second time interval and for temporally aligning an end of a temporal last slot with the slot basis of the mobile wireless communication network by forming an earlier, e.g., first, frame of the plurality of frames as a mini-frame.

According to an embodiment, the apparatus is configured for transmitting a plurality of frames during the second time interval and for temporally aligning an end of a temporal last frame with the slot basis of the mobile wireless communication network by forming the last frame of the plurality of frames as a mini-frame.

According to an embodiment, at least one frame of the plurality of frames exceeds or falls short of a slot boundary.

According to an embodiment, the apparatus is configured for transmitting a plurality of frames during the second time interval, wherein the apparatus is configured for including into a second frame one or more of a same information as in an earlier first frame, e.g.,
control information, e.g., as a Physical Sidelink Control Channel, PSCCH,
data, e.g., as a Physical Sidelink Shared Channel, PSSCH,
feedback information, e.g., as a Physical Sidelink Feedback Channel, PSFCH
a broadcast signal, e.g., as a Physical Sidelink Broadcast Channel, PSBCH,
a reference signal such as a Demodulation Reference Signal, DMRS;
an automated gain control, AGC, symbol and
a guard symbol.

According to an embodiment, the apparatus is configured for transmitting a plurality of frames during the second time interval, wherein the apparatus is configured for including into a later second frame one or more of:
a Physical Sidelink Control Channel, PSCCH,
a control within a data channel such as the PSSCH, e.g., contained in a further stage SCI, like a 2^{nd} or 3^{rd} stage SCI, MAC-CE, or RRC or PC5-RRC or any other higher layer signalling, that contains control information that relates to an earlier first frame.

According to an embodiment, the apparatus is configured for generating the control information to contain information to inform a sensing apparatus receiving the control information about a usual reservation information; and/or to inform the sensing apparatus about the slot aggregation; and/or slot format; and/or slot offset; and/or position of a further control information.

According to an embodiment, the apparatus is configured for generating the control information in the second time interval to contain a back reference to symbols transmitted in the first frame.

According to an embodiment, the apparatus is configured for generating the control information to indicate a type of a mini-frame structure used in the second time interval, e.g., the type defining how many symbols and which symbols carry one or more of AGC, DMRS, PSFCH, PSSCH, PSCCH, PSBCH and guard symbols.

According to an embodiment, the apparatus is adapted to form at least one mini-frame having a reduced number of symbols when compared to a frame occupying a complete time slot of the mobile wireless communication network and for forming the mini-frame to be free of information associated with a control channel, e.g., PSCCH, and/or associated with a feedback channel, e.g., PSFCH, and/or free of a higher layer control channel using MAC-CE or PC5-RRC or RRC or higher layer control signalling transported on the PSSCH, or the like.

The inventors have identified further possibilities to achieve additional advantages. A remaining issue with the described solution may be that when a UE carries out sensing, there is no guarantee that the subsequent time slot is also available for data transmission and usage of slot aggregation.

### Solution 1-3 of Idea 1

Solution 1-3: One way to overcome the issue of the UE not being aware of the availability of the subsequent time slot is for the UE to carry out sensing and check for availability of at least 2 or more consecutive time slots. The PSCCH in the first mini-slot will contain information regarding the presence of a slot aggregated transmission, which will implicitly inform receiving UEs that the transmission was made after carrying out LBT.

According to an embodiment, prior to using the first time slot, the apparatus is configured for sensing the channel to check for an availability of at least two or more consecutive time slots, e.g., by evaluating a received Physical Sidelink Control Channel, PSCCH.

According to an embodiment, the apparatus is configured for identifying, in a received wireless signal, information that indicates a presence of a slot aggregated transmission, e.g., thereby recognising that the transmission of the wireless signal was made after carrying out LBT.

### Solution 2: Use Existing SL Time Slot Structure with Transmission Offset

### Solution 2-1 of Idea 1

Solution 2-1 is to use the existing time slot structures such as 14 symbol SL time slots, but to transmit it after (pre-)configured offset values, or depending on how long the LBT takes for the UE to decide whether the sub channel is available.
In this case, the UE may carry out LBT and may transmit after a (pre-)configured number of symbols (or a symbol offset), e.g., depending on when the UE finds the channel/subband to be unoccupied/available.
Once the UE finds that the time slot is available after carrying out LBT, the UE can use the existing slot structure and transmit a regular frame, e.g., for 14 symbols. This may ensure that the existing slot structures with the DMRS symbols and PSFCH can be reused.
In another variant, the UE may find that it only has to use a short offset in order to be able to send slot or half-slot aligned. In this embodiment, the UE may, after having performed the intended LBT its transmission, e.g., by extending the LBT duration and/or by extending the AGC, such that if the medium stays free, the successive transmission can be performed slot or half-slot aligned. With this, the resource wastage is minimized by still utilizing a specified frame structure with minimal impact to existing UEs.
The control information transmitted in the PSCCH will indicate the symbol offset that the UE used so that it can transmit after the LBT. It can also use a new mini-slot in order to occupy the remainder of the subsequent slot in order to maintain the slot boundary, as well as have enough symbols in order so transmit the data.
   The new mini-slot may or may not contain a copy of the PSCCH previously transmitted in the full time slot.

FIG. 10B shows a schematic representation of a slot configuration in accordance with increasing the LBT time to align with a predefined reference 232 of slot 200₁ or 200₂. For example, the predefined reference may be a half of a slot or a slot boundary or any other reference such as a beginning or an end of a symbol or the like. According to an example, such an aligning may be implemented in any case to align with the next predefined reference 232 in time. According to another example, such an aligning may be implemented only if a remaining time 234 until the predefined reference 232 is reached is at most a predefined threshold, e.g., 2 or 3 symbols or the like as the short offset. In case the time is longer, the aligning may possibly be skipped to avoid unnecessary waste of resources whilst within the predefined threshold the gain obtained by aligning may compensate for the limited loss in throughput. The aligning of the beginning of the intended transmission may be implemented, e.g., by extending the first time interval 216 to an extended time interval 216′ using additional symbols 202₁ to 202₃. Alternatively or in addition the beginning of the transmission may be delayed by using one or more symbols for AGC in addition to symbol 202₄. This may be understood as reducing the second time interval 218 to a reduced time interval 218′ for the sake of temporal alignment a beginning and/or an end of transmission, e.g., of the time interval 218, 218′ respectively.

According to an embodiment, the apparatus is configured for temporally aligning a beginning or an end of the second time interval (218) with a predefined reference (232) in the time slot.

According to an embodiment, the alignment comprises to extend the first time interval and/or to use at least additional AGC symbol directly after the first time interval.

According to an embodiment, the apparatus is adapted to determine an end of the first time interval to be within a predefined threshold prior to the predefined reference and to align with the predefined reference; and/or to not align with the predefined reference if the end of the first time interval is earlier than the predefined threshold.

According to an embodiment, the predefined reference is a half-slot or an end of a slot or a predefined number of symbols within a slot, e.g., based on the size of the supported mini-frames or mini-slots.

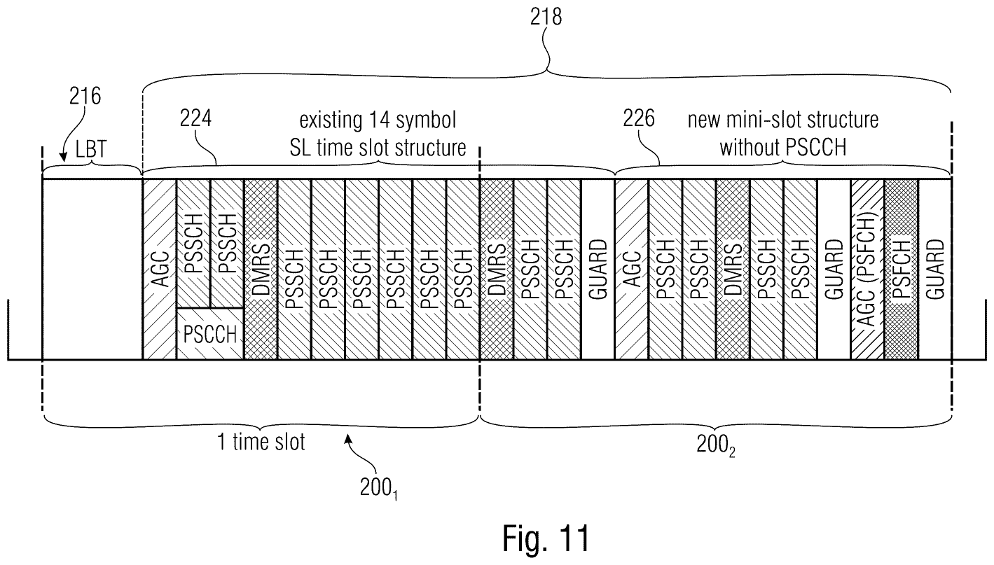

FIG. 11 shows a schematic representation of an existing Rel-16 slot structure 224 that is transmitted after the proposed advantageous LBT, followed by a new mini-slot 226 having a reduced number of symbols, e.g., 10 symbols.

While this may not strictly follow the time slot boundaries, it may still define slots using the existing boundaries, but would also use the same NR V2X slot structures.

According to a network configuration, there may be only a limited number of offsets (pre-) configured in order to enable an RX UE to be able to receive from multiple TX UEs, and be able to find a 14 symbol or a mini-slot duration time slot for its own transmissions.

In this solution, solution 1-3 may additionally be employed for the UE to carry out sensing for consecutive time slots to check for their availability.

According to an embodiment, after having performed the LBT procedure, the apparatus is configured for transmitting a frame of symbols, the frame having a time duration according to the slot duration, wherein a temporal end of the frame is later than a temporal end of the time slot.

According to an embodiment, the frame comprises a frame structure corresponding to an LBT-free transmission.

According to an embodiment, the frame structure comprises a number of exactly 7 or 14 time symbols or any number between 1 to 14 symbols, with the symbols adapted to carry one or more of AGC, DMRS, PSFCH, PSSCH, PSCCH, PSBCH and guard symbols.

According to an embodiment, the first time interval includes a temporal offset of the frame with regard to an LBT-free transmission.

According to an embodiment, the apparatus is configured for including, into the wireless transmission, e.g., into the frame of symbols, control information, e.g., as a Physical Sidelink Control Channel, PSCCH, to indicate the temporal offset.

According to an embodiment, the apparatus is configured for using a mini-frame structure to occupy a remainder of a subsequent time slot to temporally align with a slot boundary of the subsequent time slot.

According to an embodiment, the apparatus is configured for selecting the temporal offset as value from a set of predefined values.

According to an embodiment, prior to using the first time slot, the apparatus is configured for sensing the channel to check for an availability of at least two or more consecutive time slots, e.g., by decoding a received Physical Sidelink Control Channel, PSCCH and/or by evaluating the presence of other transmissions by measuring the energy received on the time slot using RSRP or RSSI.

Problems with this solution: A sensing UE may check for the PSCCH in the beginning of the slot, but since the TX UE transmitted the PSCCH only after the LBT, it will not be present in the beginning of the slot. This could mislead a sensing UE to assume that the resource is available. The inventors have identified further possibilities to achieve additional advantages over this issue.

### Solution 2-2 of Idea 1

To Address the Issues of Solution 2-1, Solution 2-2 May be Implemented that Suggests to expect sensing UEs to check for the availability of a PSCCH transmission based on the (pre-)configured offsets. In other words, the UE will have to sense a subchannel in 2-3 symbols for the PSCCH after the (pre-)configured offsets. Reducing sensing to a subchannel can substantially reduce the power consumption, since the said UE only has to monitor a much smaller number of frequencies or bandwidth. Note, that monitoring large bandwidth is a large share of the battery power used in UEs.

The offsets are (pre-)configured per resource pool. This would allow the sensing UEs to be informed about where to check for the PSCCH transmission, if any.

According to an embodiment, the apparatus is configured for checking for an availability of the time slot by carrying out sensing and/or for performing the LBT procedure based on a configured or preconfigured temporal offset, e.g., per resource pool, of a received transmission.

According to an embodiment, the apparatus is configured to check for the availability in one or more of the following:
Every symbol within a time slot,
Every symbol after the temporal offset,
Only a configured or preconfigured number of symbols either after the temporal offset or based on a configured or preconfigured slot/frame definition,
   wherein the apparatus is configured for checking for the availability by decoding a received Physical Sidelink Control Channel, PSCCH and/or by evaluating the presence of other transmissions by measuring the energy received on the time slot using RSRP or RSSI measurements.

### Solution 3: Recalibration of Sensing and Resource Allocation from Slots to Symbols

Solution 3 is to recalibrate from time slots to symbols, enabling UEs to transmit on a per symbol basis and not be restricted to time slots. That is, the UE may operate on a symbol basis instead of a slot basis.

This means that the UE may transmit at the end of the LBT, e.g., with a requirement that the PSCCH will be transmitted within the first 2-3 symbols after the beginning of a transmission.

The UE need not wait for carrying out LBT at the beginning of a slot boundary, but can start LBT once it has data in its buffer and has carried out sensing to select an available resource.

The control information will inform the RX UE about the length of the scheduled transmission, by the use of an existing, or a new slot structure. The existing slot structure is restricted in its length to 14 symbols, while a new slot structure can span multiple symbols depending on the size of the data transmission.

Sensing UEs may check for PSCCH transmissions on predefined, configured or preconfigured positions or even in every symbol of a time slot, due to the flexible nature of the transmissions.

According to an embodiment, the apparatus is configured for communicating in the mobile wireless communication network on a basis of where each symbol is associated with a defined symbol duration of time depending on the subcarrier spacing used for the resource pool, wherein the apparatus is configured for transmitting, during the second time interval a number of symbols, e.g., 2 or 3 symbols, for transmitting control information, e.g., as a Physical Sidelink Control Channel, PSCCH, at a predefined location after a start of the transmission.

According to an embodiment, the apparatus is configured for transmitting during the second time interval a number of symbols after transmitting control information to transmit data, feedback, broadcast and/or reference signals, wherein the number of symbols used for each of them, along with their positions and length of transmission is based on a configured or preconfigured slot/frame/mini-frame structure.

According to an embodiment, the apparatus is configured for generating the control information to indicate a length of the transmission, e.g., by indicating a used frame or mini-frame structure.

According to an embodiment, the apparatus is configured for generating the control information so as to indicate the frame structure to comprise a number of 14 symbols or a number of symbols being different from 7 and/or 14.

### Idea 2: LBT Failure Options

Problem 2: In the case that LBT is used, and the detected channel results in an LBT failure, this may result in the UE being unable to transmit in the selected resource and subchannel. LBT failure occurs when the UE has tried to ascertain whether the subchannel is available for over the maximum contention window size. Another issue is when the UE carried out LBT for a subchannel, and any LBT carried out subsequently on the same channel results in LBT. It means that the UE is constantly being shut out of the said subchannel.

### Solution 1-1 of Idea 2

Solution 1-1 is to Switch to Another Subband or Resource Pool or SL BWP. This is Particularly viable in Mode 2 operations since the UE does not receive any assistance from the gNB. In this case, although the sensing process indicates the availability of a resource, but the LBT does not, we propose that the UE switches to another frequency band or subchannel in order to check its availability.

The UE can wait for a (pre-)configured timer before making the switch to another subchannel/subband/resource pool/SL BWP. The timer can be a global setting, or can be configured per resource pool, or per transmission, as indicated in the new SCI.

The UE can, as an alternative or in addition, also use a (pre-)configured counter in order to permit only a (pre-)configured number of LBT attempts, after which the UE will make the switch.

Furthermore, the UE can change its operating mode based on an LBT failure or a set of LBT failures. This change may be predefined, preconfigured, configured or any other default mode. That is, the apparatus may fall back to a predefined, preconfigured, configured or default configuration based on the LBT failure or set of LBT failures, e.g., in case of one or both of a timer and/or counter threshold relating to LBT failures are reached. In this case the default configuration can be configured or preconfigured in the given UE or altered by a base station in mode 1 or by another UE if operating in mode 2, e.g., via inter-UE coordination information message (IUC) or AIM.

According to an embodiment, the apparatus is configured for detecting an unavailability of the time slot associated with a frequency band for a transmission, e.g., by experiencing an LBT failure (or a set of LBT failures defined by a (pre-)configured threshold), based on the LBT procedure; and for executing one or more of the following actions in the case the channel was found to be unavailable:
a later LBT procedure on a different second frequency band to determine an availability of the second frequency band for the wireless transmission,
a switch between operating modes from Mode 2 to Mode 1, e.g. using assistance from the base station,
a switch between operating modes from Mode 1 to Mode 2, e.g. when moving out of coverage of the base station,
a switch from sidelink, e.g., PC5 interface, to conventional, e.g., Uu interface, using the base station for assistance and to route the transmission,
a trigger of a request for inter-UE coordination information from another UE in order to obtain assistance in finding another suitable resource for the transmission,
inform another UE about an LBT-failure or persistent LBT failures or about LBT failure of on a future reserved transmission, e.g. at T5 or T10, e.g., via luC message, e.g., using a luC collision indicator (CI),
a switch to a non-NR-U band, e.g., in case a failure threshold is met,
a notification to the base station or UE or RSU on its next successful transmission about the number of LBT-failures,
a drop of the transmission.

According to an embodiment, the apparatus is configured for operating in Mode 2.

According to an embodiment, the apparatus is configured for executing the LBT procedure one or more times in the channel during a configured or preconfigured LBT-timer before executing one or more of the actions.

According to an embodiment, the LBT-timer is in accordance with a network-global setting, e.g. configured or preconfigured using SIB, is configured per resource pool, e.g. configured or preconfigured using RRC signalling, or configured per transmission, e.g., as indicated in a Sidelink Control Information, SCI or via Downlink Control Information if in mode 1.

According to an embodiment, the apparatus is configured for executing the LBT procedure in the channel for a configured or preconfigured number of LBT-times before executing one or more of the actions.

According to an embodiment, the number of LBT-times is in accordance with a network-global setting, e.g. configured or preconfigured using SIB, is configured per resource pool, e.g. configured or preconfigured using RRC signalling, or configured per transmission, e.g., as indicated in a Sidelink Control Information, SCI and/or or via Downlink Control Information if in mode 1.

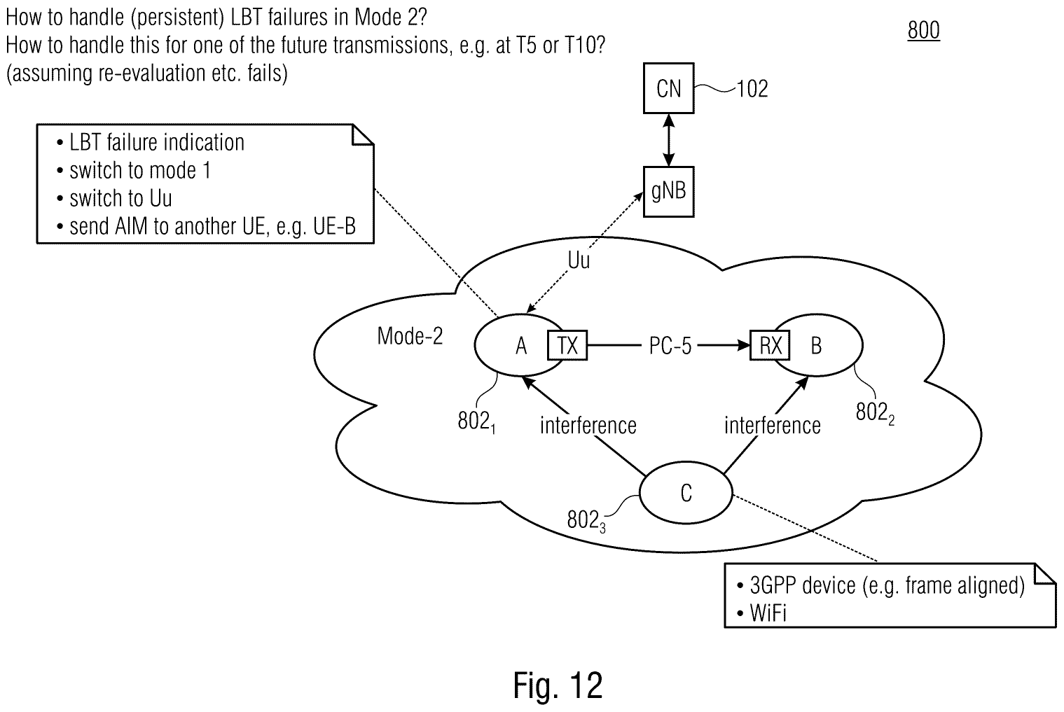

FIG. 12 shows a schematic block diagram of a mobile wireless communication network according to an embodiment, wherein mobile wireless communication network relates to a mobility driven network configuration different from WiFi® or the like.

Network 1200 comprises, for example, apparatus 802₁, 802₂ and 802₃ that may be in accordance with embodiments and possibly in accordance with the devices of network 100. In order to handle, for example, LBT failures, e.g., persistent LBT failures, in particular when operating in Mode 2, devices may use a LBT Failure indication. Alternatively or in addition, such devices may switch to Mode 1 and/or to Uu if possible, see, for example, apparatus 802₁. Alternatively or in addition a message to request for assistance (AIM) may be transmitted to other devices and/or a base station.

Furthermore, similar procedures can be applied in case LBT fails for future reserved time slots, e.g., in case of multiple resources are reserved for future transmissions. This could be the case, if a UE has successfully transmitted data at time instance TO, and intends to reserve resource for a future transmission at time instance T5 and/or T10. In case the LBT before T5 and/or T10 fails, the UE could perform a similar procedure and try to transmit the intended transmission of T5 and/or T10 in another time and/or frequency resource. E.g., this could be transmitted in another subchannel or subband or even BWP, if resource are available.

Furthermore, the action of the transmitting UE could also depend on the source of interference which caused the LBT failure. In case this was caused by a non-3GPP device, e.g. by a WiFi device, the above-described procedure could differ, e.g., the UE could perform the intended one or more future transmissions, e.g., at T5 and/or at T10, or any other future transmissions, in a frequency band which only allows transmission of 3GPP devices. That is, the device may try to switch to a non-WiFi band for future transmissions.

Alternatively or in addition, for transmission, a frequency band may be used which is currently identified to be free of any other non-3GPP devices, e.g., based on other sensing results available or based on information received by a base station or by one or more other UEs.

### Solution 1-2 of Idea 2

Solution 1-2 is for the UE to Switch the Mode of Operation, if the UE is in Coverage of the gNB and the gNB can assist the UE in sidelink transmissions. Another option for the UE is to continue its transmissions using NR-U over the Uu, where the gNB can provide resource allocation assistance for its UL transmissions to another UE.

### Solution 1-3 of Idea 2

Solution 1-3 is for the UE to Request for Resource Assistance Using Inter-UE Coordination. In the case that the UE detects LBT failure in spite of the UE sensing the availability of a resource, the UE can also use the LBT failure as a trigger to send a request to another UE-A for assistance in resource allocation via IUC.

According to solutions 1-2 and 1-3 of Idea 2, embodiments relate to one or more of the following:

An apparatus is configured for, based on the LBT failure or a plurality thereof request assistance information from at least one different apparatus, e.g., a UE and/or a base station.

According to an embodiment, the assistance information relates to resources allocation assistance information indicating resources to be used or not to be used for LBT and/or one or more future transmissions.

According to an embodiment, the resources are defined as a bitmap, as a vector in time and/or a frequency domain.

Problem 3: In this case, the UE has carried out sensing for a given transmission, and has selected a resource for the initial transmission, and has also reserved resources in the future for retransmissions. If the initial transmission attempt results in an LBT, what does the UE do with the remaining reserved resources? The remaining reserved resources are also within the same subband/resource pool of the initial transmissions.

### Solution 2-1 of Idea 2

Solution 2-1 is for the UE to attempt to carry out the retransmissions on the reserved resources. In the case that the UE has already reached the maximum number of LBT attempts or passed the LBT timer, then the UE can release these resources and can select new ones for the retransmission in another subchannel/subband/channel/resource pool/SL BWP.

If the UE decides to use another subchannel/subband/channel/resource pool/SL BWP, it would be of advantage for the UE to release the remaining reserved resources so that another UE that might find them to be favourable for their usage may utilize them. However, since the UE has already indicated in the SCI attached to the failed initial transmission about the reservation of the said resources, the UE can use them when sending an IUC to another UE.

According to an embodiment, the apparatus is configured for reserving a plurality of resources within time slots which can also relate to resource sets, time slots or the like on the channel for a plurality of transmissions and for performing the LBT for a first resource associated with a temporal first of the plurality of transmissions and to experience an LBT failure indicating an unavailability; wherein the apparatus is configured for releasing resources associated with one or more later transmissions.

According to an embodiment, the apparatus is configured for transmitting information for informing a different apparatus about releasing the resources using a resource of the reserved resources by using inter-UE coordination messages or by informing a base station or RSU via uplink control information, e.g., in mode 1.

According to an embodiment, the other apparatus is one or more of
a base station, e.g., gNB in NR, or eNB in LTE,
a road side unit, RSU,
another UE (e.g., P-UE, V2X-UE, normal UE, etc.).

According to an embodiment, the other device is a UE and the information is sent via one or more of
a sidelink, e.g., PC5,
as a relayed information via Uu via a base station or RSU.

According to an embodiment, the information is sent via an inter-UE coordination (luC) information message, e.g. included in a 1^{st} and/or 2^{nd}-stage SCI or a new 2nd or 3^{rd}-stage SCI or send via PC5-RRC, RRC, MAC-CE or higher layer control message.

### Further Solution to be Applied Together with or Independently from Other Solutions

### New 2nd Stage SCI Format Parameters

Based on the solutions discussed in the previous sections, embodiments relate to introduce a new 2^{nd} stage SCI format 2_D, to be used for transmissions in the unlicensed band. The possible parameters in the SCI, apart from those already specified for data transmission, are listed below:
Indication of the usage of slot aggregation, explicitly or implicitly directing the RX UE to continue receiving in the subsequent time slot. This can be done by stating that a mini-slot format was used for transmission in the previous time slot (Problem 1 Solution 1-2).
Back reference indicator: The PSCCH within the 2^{nd} time slot could have a back reference indicating the type of mini-slot frame structure used in the 1^{st} time slot. The type can refer to the (pre-)configured mini-slot structure with the parameter indicating an index.
Indication of the number of symbols used to offset the transmission (Problem 1 Solution 2-1). The indication can also be an index from a list of (pre-)configured offsets that are permissible for use in a given resource pool.
Length of transmission (Problem 1 Solution 3). The indication will inform the RX UE about how long the current transmission is going to be, so that it can implicitly identify the symbols that are containing DMRS, PSFCH etc.
Indication of slot structure to be used (Problem 1 Solution 3). In the case that the UE uses both mini-slots and full slots, with varying positions of the PSCCH, PSSCH, PSFCH (if present) and DMRS, the parameter can indicate an index from a list of (pre-)configured slot structures that are permissible for use in a given resource pool.
LBT timer (e.g., as described in connection with Idea 2 to solve Problem 2, Solution 1-1).
LBT counter (e.g., as described in connection with Idea 2 to solve Problem 2, Solution 1-1).

Such an apparatus in accordance with embodiments may be apparatus configured for transmitting a Control Information, SCI, indicating at least one of:
an indication of the usage of slot aggregation, explicitly or implicitly;
a back reference indicator; wherein a PSCCH within an aggregated later frame comprises a back reference, e.g., indicating a type of mini-frame structure used in an earlier frame;
an indication of a number of symbols used to offset the transmission with respect to a slot structure, e.g., slot boundary, of the mobile wireless communication network;
information indicating a length of transmission, e.g., to inform a receiving apparatus about how long the current transmission is going to be, so that it can implicitly identify the symbols that are containing a Demodulation Reference Signal DMRS, a Physical Sidelink Feedback Channel, PSFCH, etc.;
information indicating one or more future transmissions, e.g., pre-reservations,
information if a non-3GPP technology is present in this channel or neighbouring channels,
information if a 3GPP RAT, e.g., another NR or LTE-system, is operating in this channel or neighbouring subchannels,
an indication of a slot structure or slot format or frame format to be used;
information indicating an LBT-timer;
Information indicating an LBT-counter.

According to an embodiment, the Control Information is in the form of a first stage, second stage or a n-stage control information. The parameters may be included in one or more of these stages, and/or the control information may be transmitted on the PSCCH and/or PSSCH, and/or the control information may be sent via a physical layer over sidelink or Uu, PC5-RRC, RRC, MAC-CE or higher layer control messages.

Whilst at least some of details provided herein relate to the advantageous modifications applied to a transmitting apparatus, the invention also provides for advantageous modifications related to a receiving apparatus. For example, the apparatus receives symbols that occupy, based on LBT only a part of the slot, possibly deviating from known mini-slots. That is, the behavior of the transmitting device may be considered by the receiving device, in particular in view of using a part of the lost for LBT and/or for using slot aggregation.

Alternatively or in addition, such a receiving apparatus may be expected to carry out sensing in all the symbols of a time slot, e.g., because it is unaware of where the PSCCH is being transmitted.

Such an apparatus may be configured for sensing in all the symbols of a received time slot for control information, e.g., contained in a Physical Sidelink Control Channel and/or contained within a Physical Sidelink Share Channel.

Alternatively or in addition, such a receiving apparatus may, if there are a (pre-)configured set of mini-slots and mini-slot formats defined (either system-wide or per resource pool), sense for PSCCH transmissions on the symbols where the PSCCH is expected to be transmitted according to these mini-slot formats.

Such an apparatus may be configured for sensing for PSCCH transmissions on the symbols where the PSCCH is expected to be transmitted according to a preconfigured or configured mini-slot formats used for communication.

If there are a (pre-)configured set of offsets defined (either system-wide or per resource pool), the apparatus may sense for PSCCH transmissions on the 2nd, 3rd or 4th symbols. This is because using the offset would mean using an existing slot format, where the first symbol is used for AGC, and the PSCCH is within the next 2-3 symbols.

Such an apparatus may be configured for sensing for PSCCH transmissions in accordance with a (pre-)configured set of offsets defined, e.g., either system-wide or per resource pool, for an offset of a transmitted slot.

If slot aggregation is enabled in a system wide or per resource pool manner, if the apparatus detected a transmission by measuring the energy in the first slot, but could not decode the PSCCH, the apparatus should retain the reception in its buffer. This is to account for the possibility that a mini-slot was transmitted in the first slot, with or w/o PSCCH, but the subsequent time slot contains a 14 symbol slot structure where the UE can decode the PSCCH pointing to the data transmitted in the first mini-slot.

Such an apparatus may be configured for measuring an energy in a first slot of aggregated slots, and for retaining the received information in its buffer and for using control information of a later slot for decoding.

If the apparatus is sensing and looking for resources to carry out a transmission, the UE should look for consecutive available time slots, in order to incorporate the slot aggregation aspect, similar to solution 1-3 of Idea 1.

Such an apparatus may be configured for sensing and looking for resources to carry out a transmission, and for including into the procedure consecutive available time slots, in order to use slot aggregation for a transmission.

The present invention provides improvements and enhancements in the wireless communication system addressing the above described problems. The wireless communication system may use one or more subbands, also referred to as channels or subchannels or frequency bands of a NR carrier, wherein a frequency band includes a start frequency, an end frequency and all intermediate frequencies between the start and end frequencies. A subband may have a predefined bandwidth, like 10 or 20 MHz. When using a plurality of subbands, the operation is also referred to as a wideband operation.

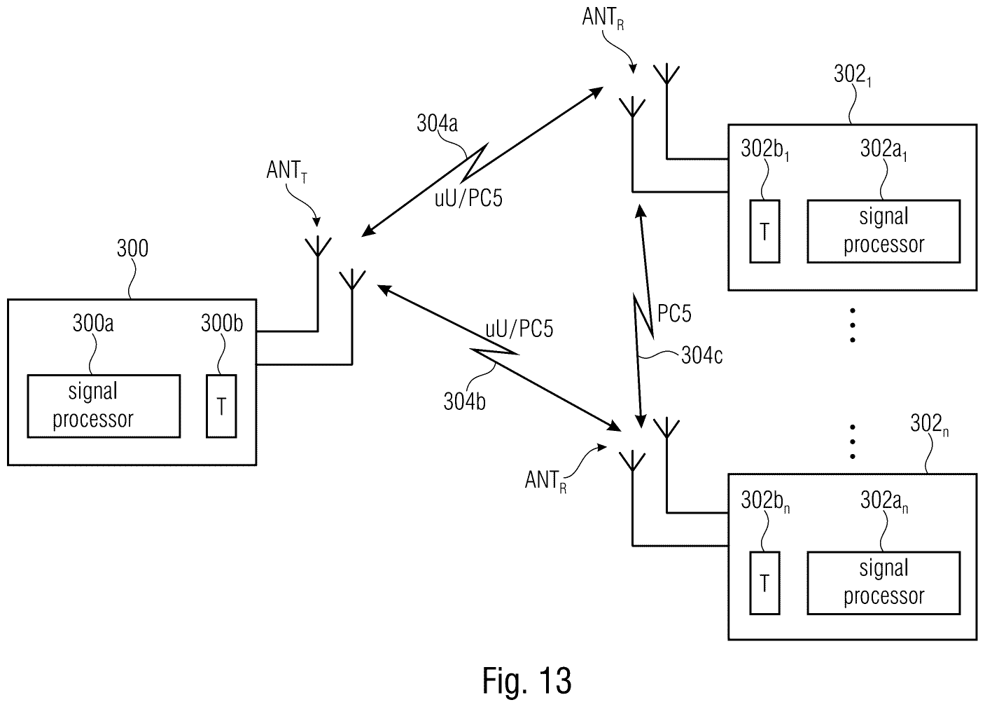

Embodiments of the present invention may be implemented in a wireless communication system as depicted in FIG. 1 including base stations and users, like mobile terminals or IoT devices. FIG. 13 is a schematic representation of a wireless communication system including a transmitter 300, like a base station, and one or more receivers 302₁ to 302ₙ, like user devices, UEs. The transmitter 300 and the receivers 302 may communicate via one or more wireless communication links or channels 304a, 304b, 304c, like a radio link. The transmitter 300 may include one or more antennas ANT_{T} or an antenna array having a plurality of antenna elements, a signal processor 300a and a transceiver 300b, coupled with each other. The receivers 302 include one or more antennas ANT_{R} or an antenna array having a plurality of antennas, a signal processor 302a₁, 302aₙ, and a transceiver 302b₁, 302bₙ coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs 302 and the base stations 300 may operate in accordance with the inventive teachings described herein.

The present invention provides a computer program product comprising instructions which, when the program is executed by a computer, causes the computer to carry out one or more methods in accordance with the present invention.

With regard to the above-described embodiments of the various aspects of the present invention, it is noted that they have been described in an environment in which a communication is between a transmitter, like a gNB or a UE, and a receiver, like a UE and a gNB. However, the invention is not limited to such a communication, rather, the above-described principles may equally be applied for a device-to-device communication, like a D2D, V2V, V2X communication. In such scenarios, the communication is over a sidelink between the respective devices. The transmitter is a first UE and the receiver is a second UE communicating using the sidelink resources.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, a described device may be or may comprise a user device, UE, e.g., one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, and/or the base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

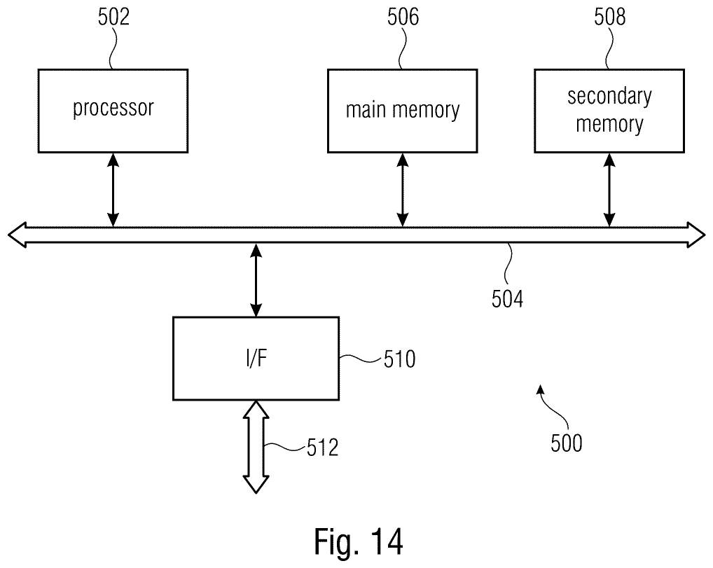

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 14 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus configured for communicating in a mobile wireless communication network, the apparatus comprising a wireless interface for transceiving wireless signals in the mobile wireless communication network in an unlicensed band; wherein the apparatus is configured for
communicating over a sidelink, SL, in the mobile wireless communication system, the sidelink providing for a plurality of time slots, each time slot comprising a slot duration,
wherein the apparatus is configured for using at least a first time interval of the slot duration, to perform a listen-before-talk, LBT, procedure to determine an availability of the time slot; and/or to use a second time interval of the slot duration for a wireless transmission based on the determined availability; and/or
wherein the apparatus is configured for using at least a first slot duration, to perform a listen-before-talk, LBT, procedure to determine an availability of at least a part of a later second time slot, and/or to use the at least part of the later second time slot for a wireless transmission based on the determined availability.

2. The apparatus of claim 1, wherein the apparatus is configured for communicating in the mobile wireless communication network on one or more of the following:
a basis of time slots, where each time slot comprises a plurality of symbols across time,
a basis of symbols, where each symbol is associated with a defined symbol duration of time depending on the sub carrier spacing used for a resource pool,
a basis of a configured or preconfigured set of symbols.

3. The apparatus of claim 1, wherein the apparatus is configured for using the second time interval at least as a remainder of the slot duration after the first time interval.

4. The apparatus of claim 1, wherein the apparatus is configured for transmitting a mini-frame in the second time interval that comprises a reduced number of symbols when compared to a capacity of a time slot of the mobile wireless communication network.

5. The apparatus of claim 4, wherein the capacity of a time slot corresponds to a frame that comprises of one or more time slots; wherein a time slot comprises of one or more symbols; wherein the mini-frame comprises of one or more mini-slots; wherein a mini-slot or mini-frame comprises one or more symbols; wherein the number of symbols are less than that of the number of symbols in a time slot.

6. The apparatus of claim 4, wherein a mini-frame comprises one or more of:
less OFDM symbols than the capacity of the time slot,
any number of OFDM symbols from the set {1 . . . 13},
other mini-frames, where the total number of OFDM symbols does not exceed a slot boundary,
a combination of a plurality of mini-frames to form a new, longer mini-frame.

7. The apparatus of claim 1, wherein the apparatus is configured for temporally aligning an end of the second time interval with an end of a time slot of the mobile wireless communication network.

8. The apparatus of claim 1, wherein the apparatus is configured for temporally aligning a beginning or an end of the second time interval with a predefined reference in the time slot.

9-11. (canceled)

12. The apparatus of claim 1, wherein the apparatus is configured or preconfigured to transmit in one or more channels or sub-channels across frequency in the second time interval.

13. The apparatus of claim 12, wherein the sub-channels comprises one or more resource blocks across frequency, and/or
wherein the channels or sub-channels are defined within one or more resource pools, and/or
wherein the subbands are defined within a bandwidth part;
wherein each channel, subchannel or subband comprises of one or more contiguous or non-contiguous resource blocks.

14. The apparatus of claim 13, wherein the frequency resources are interlaced according to a configured or preconfigured scheme.

15. (canceled)

16. The apparatus of claim 1, wherein the apparatus is configured for carrying out sensing prior to perform LBT to determine a resource to be used for a transmission and/or for an initial transmission and/or to determine one or more future reserved resources, which is subject to re-evaluation, to be used for retransmissions,
wherein the apparatus is configured to perform LBT to determine the availability of the resource for the transmission and/or the initial transmission and/or the one or more future reserved resources before the wireless transmission.

17-26. (canceled)

27. The apparatus of claim 1, wherein the apparatus is configured for aggregating the first time slot and at least one second time slot to an aggregated set of time slots and for using the second time slot in combination with the second time interval of the first time slot for transmissions.

28-33. (canceled)

34. The apparatus of claim 27, wherein the apparatus is configured for transmitting a plurality of frames during the second time interval, wherein the apparatus is configured for including into a later second frame one or more of:
a Physical Sidelink Control Channel, PSCCH,
a control within a data channel such as the PSSCH, e.g., comprised by a further stage SCI, like a 2nd or 3^{rd} stage SCI, MAC-CE, or RRC or PC5-RRC or any other higher layer signalling, that comprises control information that relates to an earlier first frame,
wherein the apparatus is configured for generating the control information to comprise information to inform a sensing apparatus receiving the control information about a usual reservation information; and/or to inform the sensing apparatus about the slot aggregation; and/or slot format; and/or slot offset; and/or position of a further control information.

35-38. (canceled)

39. The apparatus of claim 27, wherein prior to using the first time slot, the apparatus is configured for sensing the channel to check for an availability of at least two or more consecutive time slots, e.g., by evaluating a received Physical Sidelink Control Channel, PSCCH.

40-54. (canceled)

55. The apparatus of claim 1, wherein the apparatus is configured for detecting an unavailability of the time slot associated with a frequency band for a transmission, e.g., by experiencing an LBT failure or a set of LBT failures e.g., defined by a (pre-) configured threshold, based on the LBT procedure; and
for executing one or more of the following actions in the case the channel was found to be unavailable:
a later LBT procedure on a different second frequency band to determine an availability of the second frequency band for the wireless transmission,
a switch between operating modes from Mode 2 to Mode 1, e.g. using assistance from the base station,
a switch between operating modes from Mode 1 to Mode 2, e.g. when moving out of coverage of the base station,
a switch from sidelink, e.g., PC5 interface, to conventional, e.g., Uu interface, using the base station for assistance and to route the transmission,
a trigger of a request for inter-UE coordination information from another UE in order to acquire assistance in finding another suitable resource for the transmission,
inform another UE about an LBT-failure or persistent LBT failures or about LBT failure of on a future reserved transmission, e.g. at T5 or T10, e.g., via luC message, e.g., using a luC collision indicator (CI),
a switch to a non-NR-U band, e.g., in case a failure threshold is met,
a notification to a base station or UE or RSU on its next successful transmission about the number of LBT-failures,
a drop of the transmission.

56-66. (canceled)

67. The apparatus of claim 1, wherein the apparatus is configured for reserving a plurality of resources within time slots on the channel for a plurality of transmissions and for performing the LBT for a first resource associated with a temporal first of the plurality of transmissions and to experience an LBT failure indicating an unavailability; wherein the apparatus is configured for releasing resources associated with one or more later transmissions.

68-71. (canceled)

72. The apparatus of claim 1,
wherein the apparatus is configured for transmitting a Control Information, SCI, indicating at least one of:
an indication of the usage of slot aggregation, explicitly or implicitly;
a back reference indicator; wherein a PSCCH within an aggregated later frame comprises a back reference, e.g., indicating a type of mini-frame structure used in an earlier frame;
an indication of a number of symbols used to offset the transmission with respect to a slot structure, e.g., slot boundary, of the mobile wireless communication network;
information indicating a length of transmission, e.g., to inform a receiving apparatus about how long the current transmission is going to be, so that it can implicitly identify the symbols that comprise a Demodulation Reference Signal DMRS, a Physical Sidelink Feedback Channel, PSFCH, etc.;
information indicating one or more future transmissions, e.g., pre-reservations,
information if a non-3GPP technology is present in this channel or neighbouring channels,
information if a 3GPP RAT, e.g., another NR or LTE-system, is operating in this channel or neighbouring subchannels,
an indication of a slot structure or slot format or frame format to be used;
information indicating an LBT-timer;
information indicating an LBT-counter.

73-81. (canceled)

82. A computer-implemented method for operating an apparatus to communicate in a mobile wireless communication network in an unlicensed band, the apparatus comprising a wireless interface for transceiving wireless signals in the mobile wireless communication network; the method comprising:
communicating over a sidelink, SL, in the mobile wireless communication system, the sidelink providing for a plurality of time slots, each time slot comprising a slot duration,
using at least a first time interval of the slot duration, to perform a listen-before-talk, LBT, procedure to determine an availability of the time slot; and to use a second time interval of the slot duration for a wireless transmission based on the determined availability; and/or
using at least a first slot duration, to perform a listen-before-talk, LBT, procedure to determine an availability of at least a part of a later second time slot, e.g., a full slot, a mini-slot or a mini-frame, and/or to use the at least part of the later second time slot for a wireless transmission based on the determined availability.

83. A computer-implemented method for operating an apparatus to communicate in a mobile wireless communication network, the apparatus comprising a wireless interface for transceiving wireless signals in the mobile wireless communication network; the method comprising:
receiving the wireless transmission of the method of claim 82; and
operating accordingly.

84-85. (canceled)
